(19) United States
(12) Patent Application Publication
(10) Pub. No.: US 2025/0053976 A1
(43) Pub. Date: Feb. 13, 2025

(54) DATA PROCESSING METHOD AND APPARATUS BASED ON MULTI-BLOCKCHAIN, ELECTRONIC DEVICE, COMPUTER-READABLE STORAGE MEDIUM, AND COMPUTER PROGRAM PRODUCT

(71) Applicant: TENCENT TECHNOLOGY (SHENZHEN) COMPANY LIMITED, Shenzhen (CN)

(72) Inventor: Gengliang ZHU, Shenzhen (CN)

(73) Assignee: TENCENT TECHNOLOGY (SHENZHEN) COMPANY LIMITED, Shenzhen (CN)

(21) Appl. No.: 18/929,686

(22) Filed: Oct. 29, 2024

Related U.S. Application Data
(63) Continuation of application No. PCT/CN2023/121990, filed on Sep. 27, 2023.

(30) Foreign Application Priority Data
Nov. 2, 2022 (CN) 202211362635.7

(51) Int. Cl. G06Q 20/40; G06Q 20/38

(52) U.S. Cl. CPC G06Q 20/401; G06Q 20/3825

(57) ABSTRACT

A data processing method performed by a first consensus node in a first network of a multi-blockchain, includes: obtaining a clearing transaction request submitted by a service object; performing verification on an identity authority of a service clearing node to obtain an identity authority verification result; invoking a first authority clearing contract associated with a first authority contract to obtain first service data and first ledger data; obtaining first contract data corresponding to the first ledger data from a contract database corresponding to a first main chain; using the first service data, the first ledger data, and the first contract data as first clearing response information corresponding to the clearing transaction request; and returning the first clearing response information to a first-type clearing node having authority to obtain the first service data, to cause the first-type clearing node to recover a sub-ledger corresponding to the first ledger data.

### CROSS-REFERENCE TO RELATED APPLICATIONS

This application is a continuation application of International Application No. PCT/CN2023/121990 filed on Sep. 27, 2023, which claims priority to Chinese Patent Application No. 202211362635.7, filed with the China National Intellectual Property Administration on Nov. 2, 2022, the disclosures of each being incorporated by reference herein in their entireties.

### FIELD

The disclosure relates to the field of blockchain technologies, and in particular, to a data processing method and apparatus based on a multi-blockchain, an electronic device, a computer-readable storage medium, and a computer program product.

### BACKGROUND

When being configured to process related transaction services (for example, a transaction service A and an extended transaction service B of the transaction service A), an existing blockchain data processing system relies on a blockchain network built on a single-chain structure. In this case, all service processors accessing the blockchain network in a form of a terminal or a server may process the related transaction services (for example, the transaction service A and the extended transaction service B) on a same blockchain corresponding to the blockchain network.

For a single blockchain, there may be packaging transaction service execution results corresponding to related services on which the service processors participate in processing respectively (for example, a service processor C1 participates in processing the transaction service A and a service processor C2 participates in processing the extended transaction service B) into a same block (for example, a block D). Based on this, when both the service processor C1 and the service processor C2 may perform data clearing on the single blockchain, all the transaction execution results are cleared from the same block (for example, the block D) on the single blockchain. For a service processor on the single blockchain, a transaction execution result related to the service processor may be cleared together with a transaction execution result unrelated to the service processor, which means that it may be difficult for an existing blockchain clearing solution to ensure data security during data clearing.

### SUMMARY

Provided are a data processing method and apparatus based on a multi-blockchain, an electronic device, a computer-readable storage medium, and a computer program product.

According to some embodiments, a data processing method performed by a first consensus node in a first network of a multi-blockchain, includes: obtaining, through a service clearing node, a clearing transaction request submitted by a service object including a first service object associated with a first service network, wherein the first service network is associated with the first network, and the first network is a consensus network corresponding to a first main chain of the multi-blockchain; using a node identifier of the service clearing node carried in the clearing transaction request as a target node identifier; performing verification on an identity authority of the service clearing node based on the target node identifier and a first authority contract on the first main chain, to obtain an identity authority verification result corresponding to the service clearing node; invoking a first authority clearing contract associated with the first authority contract to obtain first service data associated with a first-type clearing node corresponding to the first service object that is a service node in the first service network and first ledger data corresponding to the first service data from the first main chain, based on: the identity authority verification result indicating the service clearing node is the first-type clearing node, and a node authority of the first-type clearing node being a first-type clearing authority indicating the first-type clearing node has data obtaining authority to obtain the first service data which is visible to the first service object from the first main chain; obtaining first contract data corresponding to the first ledger data from a contract database corresponding to the first main chain; using the first service data, the first ledger data, and the first contract data as first clearing response information corresponding to the clearing transaction request; and returning the first clearing response information to the first-type clearing node, to cause the first-type clearing node to recover a sub-ledger corresponding to the first ledger data based on the first clearing response information.

According to some embodiments, a data processing apparatus operating a first consensus node of a first network of a multi-blockchain, includes: at least one memory configured to store computer program code; and at least one processor configured to read the program code and operate as instructed by the program code, the program code including: clearing request obtaining code configured to cause at least one of the at least one processor to: obtain, through a service clearing node, a clearing transaction request submitted by a service object including a first service object associated with a first service network, wherein the first service network is associated with the first network, and the first network is a consensus network corresponding to a first main chain of the multi-blockchain; and use a node identifier of the service clearing node carried in the clearing transaction request as a target node identifier; identity authority verification code configured to cause at least one of the at least one processor to perform verification on an identity authority of the service clearing node based on the target node identifier and a first authority contract on the first main chain, to obtain an identity authority verification result corresponding to the service clearing node; first clearing invoking code configured to cause at least one of the at least one processor to: invoke a first authority clearing contract associated with the first authority contract to obtain first service data associated with a first-type clearing node corresponding to the first service object that is a service node in the first service network and first ledger data corresponding to the first service data from the first main chain, based on: the identity authority verification result indicating the service clearing node is the first-type clearing node, and a node authority of the first-type clearing node being a first-type clearing authority indicating the first-type clearing node has data obtaining authority to obtain the first service data which is visible to the first service object from the first main chain; and obtain first contract data corresponding to the first ledger data from a contract database corresponding to the first main chain; and first clearing response returning code configured to cause at least one of the at least one processor to: use the first service data, the first ledger data, and the first contract data as first clearing response information corresponding to the clearing transaction request; and return the first clearing response information to the first-type clearing node, to cause the first-type clearing node to recover a sub-ledger corresponding to the first ledger data based on the first clearing response information.

According to some embodiments, a non-transitory computer-readable storage medium, storing computer code for operating a first consensus node of a first network of a multi-blockchain, which, when executed by at least one processor, causes the at least one processor to at least: obtain, through a service clearing node, a clearing transaction request submitted by a service object including a first service object associated with a first service network, wherein the first service network is associated with the first network, and the first network is a consensus network corresponding to a first main chain of the multi-blockchain; use a node identifier of the service clearing node carried in the clearing transaction request as a target node identifier; perform verification on an identity authority of the service clearing node based on the target node identifier and a first authority contract on the first main chain, to obtain an identity authority verification result corresponding to the service clearing node; invoke a first authority clearing contract associated with the first authority contract to obtain first service data associated with a first-type clearing node corresponding to the first service object that is a service node in the first service network and first ledger data corresponding to the first service data from the first main chain, based on: the identity authority verification result indicating the service clearing node is the first-type clearing node, and a node authority of the first-type clearing node being a first-type clearing authority indicating the first-type clearing node has data obtaining authority to obtain the first service data which is visible to the first service object from the first main chain; obtain first contract data corresponding to the first ledger data from a contract database corresponding to the first main chain; use the first service data, the first ledger data, and the first contract data as first clearing response information corresponding to the clearing transaction request; and return the first clearing response information to the first-type clearing node, to cause the first-type clearing node to recover a sub-ledger corresponding to the first ledger data based on the first clearing response information.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of a hierarchical structure of a blockchain network according to some embodiments.

FIG. 2 is a schematic diagram of a scenario of a blockchain electronic bill platform based on a multi-blockchain according to some embodiments.

FIG. 3 is a schematic diagram of a data processing method based on a multi-blockchain according to some embodiments.

FIG. 4 is a schematic diagram of a scenario of obtaining a clearing transaction request through a first chain entrance according to some embodiments.

FIG. 5 is a schematic diagram of data exchanging during data clearing according to some embodiments.

FIG. 6 is a schematic diagram of a scenario of obtaining service authority verification information associated with a first service according to some embodiments.

FIG. 7 is a schematic diagram of a data processing method based on a multi-blockchain according to some embodiments.

FIG. 8 is a schematic diagram of data exchanging of a blockchain system based on a multi-blockchain according to some embodiments.

FIG. 9 is a timing diagram of a data processing method based on a multi-blockchain according to some embodiments.

FIG. 10 is a schematic structural diagram of a data processing apparatus based on a multi-blockchain according to some embodiments.

FIG. 11 is a schematic structural diagram of a data processing apparatus based on a multi-blockchain according to some embodiments.

FIG. 12 is a schematic structural diagram of an electronic device according to some embodiments.

FIG. 13 is a schematic diagram of a data processing system based on a multi-blockchain according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

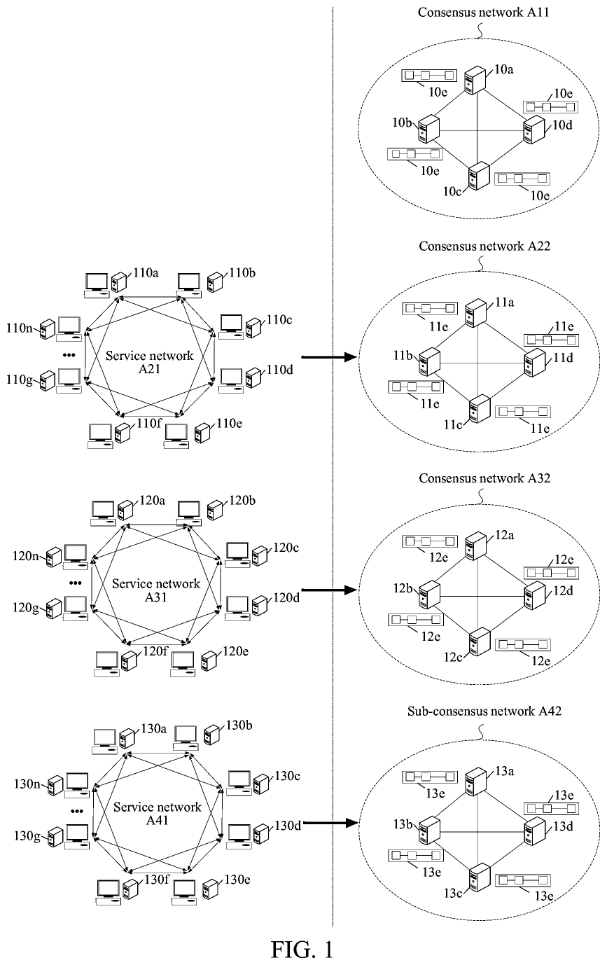

Referring to FIG. 1, FIG. 1 is a schematic diagram of a hierarchical structure of a blockchain network according to some embodiments. The hierarchical structure shown in FIG. 1 is applied to a blockchain system. A blockchain network corresponding to the blockchain system includes a plurality of service networks deployed in a public network and a plurality of consensus networks deployed in a private cloud. As shown in FIG. 1, the plurality of service networks herein may include a service network A21, a service network A31, and a service network A41 shown in FIG. 1, and the plurality of consensus networks herein may include a consensus network A11, a consensus network A22, a consensus network A32, and a sub-consensus network A42 shown in FIG. 1.

In the consensus network A11 shown in FIG. 1, a plurality of consensus nodes are deployed. The plurality of consensus nodes herein may include a consensus node 10a, a consensus node 10b, a consensus node 10c, and a consensus node 10d shown in FIG. 1. A quantity of consensus nodes deployed in the consensus network A11 is not limited. As shown in FIG. 1, a blockchain jointly maintained by the plurality of consensus nodes deployed in the consensus network A11 may be a blockchain 10e shown in FIG. 1.

The service network A21 shown in FIG. 1 is a service network having an association relationship (for example, a transaction chaining relationship and a transaction clearing relationship) with the consensus network A22. A plurality of service nodes are deployed in the service network A21 shown in FIG. 1. The plurality of service nodes herein may include a service node 110a, a service node 110b, a service node 110c, a service node 110d, a service node 110c, a service node 110f, a service node 110g, . . . , and a service node 110n shown in FIG. 1. Similarly, in the consensus network A22 shown in FIG. 1, a plurality of consensus nodes are deployed. The plurality of consensus nodes herein may include a consensus node 11a, a consensus node 11b, a consensus node 11c, and a consensus node 11d shown in FIG. 1. Neither a quantity of service nodes deployed in the service network A21 nor a quantity of consensus nodes deployed in the consensus network A22 is limited herein. As shown in FIG. 1, when a service node deployed in the service network A21 is configured to perform data clearing, data exchanging may be performed with a consensus node in the consensus network A22 shown in FIG. 1, to clear a transaction related to the service node from a blockchain (for example, a main blockchain 11e shown in FIG. 1) corresponding to the consensus network A22, and may further clear ledger data and contract data of the transaction related to the service node.

Similarly, the service network A31 shown in FIG. 1 is a service network having an association relationship (for example, a transaction chaining relationship and a transaction clearing relationship) with the consensus network A32. A plurality of service nodes are deployed in the service network A31 shown in FIG. 1. The plurality of service nodes herein may include a service node 120a, a service node 120b, a service node 120c, a service node 120d, a service node 120e, a service node 120f, a service node 120g, . . . , and a service node 120n shown in FIG. 1. Similarly, in the consensus network A32 shown in FIG. 1, a plurality of consensus nodes are deployed. The plurality of consensus nodes herein may include a consensus node 12a, a consensus node 12b, a consensus node 12c, and a consensus node 12d shown in FIG. 1. Neither a quantity of service nodes deployed in the service network A31 nor a quantity of consensus nodes deployed in the consensus network A32 is limited herein. As shown in FIG. 1, when a service node deployed in the service network A31 is configured to perform data clearing, data exchanging may be performed with a consensus node in the consensus network A32 shown in FIG. 1, to clear a transaction related to the service node from a blockchain (for example, a main blockchain 12e shown in FIG. 1) corresponding to the consensus network A32, and may further clear ledger data and contract data of the transaction related to the service node.

By analogy, the service network A41 shown in FIG. 1 is a service network having an association relationship (for example, a transaction chaining relationship and a transaction clearing relationship) with the sub-consensus network A42. A plurality of service nodes are deployed in the service network A41 shown in FIG. 1. The plurality of service nodes herein may include a service node 130a, a service node 130b, a service node 130c, a service node 130d, a service node 130c, a service node 130f, a service node 130g, . . . , and a service node 130n shown in FIG. 1. Similarly, in the sub-consensus network A42 shown in FIG. 1, a plurality of consensus nodes are deployed. The plurality of consensus nodes herein may include a consensus node 13a, a consensus node 13b, a consensus node 13c, and a consensus node 13d shown in FIG. 1. Neither a quantity of service nodes deployed in the service network A41 nor a quantity of consensus nodes deployed in the sub-consensus network A42 is limited herein. As shown in FIG. 1, when a service node deployed in the service network A41 is configured to perform data clearing, data exchanging may be performed with a consensus node in the sub-consensus network A42 shown in FIG. 1, to clear a transaction related to the service node from a blockchain (for example, a sub-blockchain 13e shown in FIG. 1) corresponding to the sub-consensus network A42, and may further clear ledger data and contract data of the transaction related to the service node.

In some embodiments, a blockchain (a main blockchain 10e shown in FIG. 1) corresponding to the consensus network A11, a blockchain (a main blockchain 11e shown in FIG. 1) corresponding to the consensus network A22, a blockchain (a main blockchain 12c shown in FIG. 1) corresponding to the consensus network A32, and a blockchain (a sub-blockchain 14e shown in FIG. 1) corresponding to the sub-consensus network A42 may be collectively referred to as the multi-blockchain involved in the blockchain system.

A blockchain (the main blockchain 10e shown in FIG. 1) corresponding to the consensus network A11, a blockchain (the main blockchain 11e shown in FIG. 1) corresponding to the consensus network A22, and a blockchain (the main blockchain 12e shown in FIG. 1) corresponding to the consensus network A32 may be configured for constructing a three-chain system in the blockchain system. In addition, based on the three-chain system, for some service scenarios, such as a temporary service scenario and some local service scenarios in which a large amount of data may be processed in batches, the sub-consensus network A42 shown in FIG. 1 may be constructed based on the consensus network A22 and the consensus network A32 shown in FIG. 1, to process a temporary service in the foregoing temporary service scenario through a sub-consensus node in the sub-consensus network A42 and a local service in which a large amount of data may be processed in batches in the foregoing local service scenarios, and a waste of storage resources on the main blockchains in the foregoing three-chain system may be avoided. The services in the temporary service scenario may be collectively referred to as target sub-services. One target sub-service corresponds to one target subnetwork, and a sub-consensus node in one target subnetwork is configured to maintain one target subchain. For example, the target subchain herein may be the sub-blockchain 13e corresponding to the foregoing sub-consensus network A42. In this case, the sub-consensus network A42 may be the foregoing target subnetwork.

A sub-consensus node in the sub-consensus network A42 may include some consensus nodes (for example, a sub-consensus node 13a and a sub-consensus node 13b may be the consensus node 11a and the consensus node 11b in the consensus network A22) selected from the consensus network A22 and some consensus nodes (for example, a sub-consensus node 13c and a sub-consensus node 13d may be the consensus node 12c and the consensus node 12d in the consensus network A32) selected from the consensus network A32.

The blockchain involved in some embodiments is a novel application mode of computer technologies such as distributed data storage, point-to-point transmission, a consensus mechanism, and an encryption algorithm, and is configured to organize data in chronological order and encrypt the data into a ledger, to perform verification on, store, and update the data while preventing the data from being tampered with or forged. The blockchain may be a decentralized database. Every node in the database stores a same blockchain.

To facilitate distinction between the consensus networks in the blockchain system, in some embodiments, with reference to an application scenario of the blockchain system (for example, an electronic bill core data circulating scenario under a blockchain electronic bill platform), the consensus network A11 may be collectively referred to as a target network, and a blockchain (the main blockchain 10c) jointly maintained by consensus nodes in the target network may be collectively referred to as a target main chain. In addition, a consensus node selected from the target network and configured to perform a management service (such as a registration service and an authorization service) may be used as a target consensus node in the target network. Similarly, in some embodiments, the consensus network A22 may be collectively referred to as a first network, and a blockchain (for example, the main blockchain 11e) jointly maintained by consensus nodes in the first network may be collectively referred to as a first main chain. In addition, a consensus node selected from the first network and configured to perform a first service (the first service may be an electronic bill-associated bill service such as an electronic bill issuance service) may be used as a first consensus node in the first network. By analogy, in some embodiments, the consensus network A32 may be collectively referred to as a second network, and a blockchain (for example, the main blockchain 12e) jointly maintained by consensus nodes in the second network may be collectively referred to as a second main chain. In addition, a consensus node selected from the second network and configured to perform a second service (the second service may be an electronic bill-associated derivative service such as a credit investigation service and an enterprise qualification identification service) may be used as a second consensus node in the second network. In addition, in some embodiments, the sub-consensus network A42 may also be collectively referred to as a target subnetwork, and a blockchain (for example, the main blockchain 13c) jointly maintained by consensus nodes in the target subnetwork may be collectively referred to as a target subchain. In addition, a consensus node selected from the sub-consensus network and configured to perform a third service (the third service may be an electronic bill-associated target sub-service such as a risk control and management service performed for an enterprise) may be used as a sub-consensus node in the target subnetwork. For the consensus networks, the management service, the bill service, and the derivative service herein may all be considered as transaction services initiated by corresponding service objects.

For example, when the foregoing blockchain system is applied to a blockchain electronic bill platform, a secure and reliable blockchain electronic bill three-chain network may be constructed based on the target main chain, the first main chain, and the second main chain. In the blockchain electronic bill three-chain network, in a case that the foregoing services are independently executed in the foregoing three consensus networks, service execution results obtained by independently executing the foregoing services may be respectively stored into blockchain ledgers corresponding to the blockchains, thereby avoiding hybridity of data storage on the chains from the root.

For example, when the consensus network A11 is used as the target network in the foregoing blockchain electronic bill three-chain network, the main blockchain 10e stored in every node (for example, core nodes such as the consensus node 10a, the consensus node 10b, the consensus node 10c, and the consensus node 10d) in the consensus network A11 is the foregoing target main chain. The target main chain herein may be a management chain in the foregoing target network, and a management consensus node determined from the target network (for example, a management chain network) corresponding to the management chain may be collectively referred to as a target consensus node. In another example, when the consensus network A22 is used as the first network in the foregoing blockchain electronic bill three-chain network, the main blockchain 11e stored in every node (for example, core nodes such as the consensus node 11a, the consensus node 11b, the consensus node 11c, and the consensus node 11d) in the consensus network A22 is the first main chain. The first main chain herein may be a bill chain in the foregoing blockchain electronic bill three-chain network, and a bill consensus node determined from the first network (for example, a bill chain network) corresponding to the bill chain may be collectively referred to as a first consensus node. In some embodiments, a consensus node (for example, the foregoing bill consensus node) selected from consensus nodes of the bill chain network may be used as the first consensus node by using a consensus mechanism in the bill chain network, and the remaining consensus node other than the first consensus node in the consensus nodes of the bill chain network may be collectively referred to as a verification consensus node (in this case, the verification consensus node is a bill verification consensus node). In another example, when the consensus network A32 is used as the second network in the foregoing blockchain electronic bill three-chain network, the main blockchain 12c stored in every node (for example, core nodes such as the consensus node 12a, the consensus node 12b, the consensus node 21c, and the consensus node 12d) in the consensus network A32 is the second main chain. The second main chain herein may be an application contract chain in the foregoing blockchain electronic bill three-chain network, and an application consensus node determined from the second network corresponding to the application contract chain may be collectively referred to as a second consensus node. In some embodiments, a consensus node (for example, the foregoing application consensus node) selected from consensus nodes of the application contract chain may be used as the second consensus node by using a consensus mechanism in the second network, and the remaining consensus node other than the second consensus node in the consensus nodes of the second network corresponding to the application contract chain may be collectively referred to as a verification consensus node (in this case, the verification consensus node is an application verification consensus node).

In the foregoing blockchain system, a consensus node may be responsible for consensus in a consensus network on which a corresponding blockchain is located. For any consensus network (for example, the consensus network A22) in the foregoing three consensus networks (for example, the consensus network A11, the consensus network A22, and the consensus network A32), a process of writing transaction data in the consensus network (for example, the consensus network A22) into a corresponding blockchain ledger (for example, the ledger database) may be that: A user client transmits the transaction data to a service node. The transaction data is transferred as a baton between service nodes in a service network (the service network A21) associated with the consensus network (for example, the consensus network A22) until a consensus node (for example, the consensus node 11b) in the foregoing consensus network (for example, the consensus network A22) receives the transaction data. In this case, the consensus node (for example, the consensus node 11b) further packages the transaction data into a block, to facilitate subsequent consensus with another consensus node, and after the consensus is reached, the consensus node may write the block reaching the consensus into a ledger database of a consensus network (for example, the consensus network A22) in which the consensus node is located. The ledger database herein is a database belonging to a distributed database. For implementation details of writing transaction data into a corresponding blockchain ledger by another consensus network, reference may be made to the descriptions of writing transaction data into a corresponding blockchain ledger by the consensus network A22.

In some embodiments, after the consensus is reached, the consensus node may write, through a storage layer of a consensus network (for example, the consensus network A22) in which the consensus node is located, a block carrying the transaction data and a plurality of other blocks associated with the block into the foregoing ledger database, and limitations of the blockchain structure of the blockchain may be broken through from the root, which may improve the storage efficiency of data storage.

In the foregoing blockchain system, a smart contract may be deployed on a blockchain of a corresponding consensus network. The smart contract in a blockchain system may be understood as code executed by blockchain nodes (for example, consensus nodes). Any logic can be executed based on the smart contract, and a result can be obtained. For example, a user may invoke, in a manner of initiating a transaction chaining request through a service node (the service node 110c in the service network A21) in a service network, a smart contract (for example, a service contract deployed on the main blockchain 11e) that has been deployed on a blockchain (for example, the foregoing main blockchain 11e) in a corresponding consensus network (for example, the foregoing consensus network A22) to execute a transaction service (for example, the foregoing first service) requested by the user.

The service node 110c in the service network may transmit the transaction chaining request to a consensus node (for example, the consensus node 11a shown in FIG. 1) in a corresponding consensus network, to perform, through a chain entrance of the corresponding consensus network, access authentication on the user transmitting the transaction chaining request, and allow, when the access authentication succeeds, to transmit the transaction chaining request transmitted by the user to other consensus nodes (for example, the consensus node 11b shown in FIG. 1) in the corresponding consensus network, to invoke smart contracts run in the consensus nodes (for example, the consensus node 11a and the consensus node 11b shown in FIG. 1) to execute a transaction service requested by the user.

The user may initiate a clearing transaction request through a service node (the service node 110c in the service network A21) in a service network to request to invoke a smart contract (for example, a node authority contract and an authority clearing contract deployed on the foregoing main blockchain 11e) that has been deployed on the main blockchain that has been deployed on a blockchain (for example, the foregoing main blockchain 11e) in a corresponding consensus network (for example, the foregoing consensus network A22) to clear service data related to the user.

One or more smart contracts may be deployed on the blockchain (for example, the foregoing main blockchain 11e) of the foregoing consensus network (for example, the foregoing consensus network A22). The smart contracts may be distinguished by contract invocation addresses, contract identification numbers (identity documents, IDs), or contract names. Moreover, the transaction chaining request initiated by the service node 110c may also carry a contract invocation address, a contract identification number, or a contract name of a smart contract, to specify the smart contract that may be run. However, in the foregoing blockchain system, if the smart contract specified by the service node 110c is a smart contract that is to read data across chains (for example, a cross-chain reading contract), the consensus nodes request, based on a chain identifier specified by the cross-chain reading contract, to read data from a corresponding blockchain. The consensus nodes may mutually verify whether transaction execution results obtained after transactions are executed based on information read across chains are consistent (for example, consensus is performed), store the transaction execution results in respective local caches and local storages if the transaction execution results are consistent, and return the transaction execution results of the transaction service to the service node 110c. The local cache herein is a system memory created in the storage layer, and the local storage herein is a hard drive space created in the storage layer for data storage. When a consensus node in the consensus network is down or has a system failure, a phenomenon that data cannot be read because the data in the system memory disappears may not occur, for example, the consensus node may also read the data through the local storage created in the storage layer.

In the foregoing blockchain system, a point-to-point (P2P) network may be formed between any two blockchain nodes in any consensus network (for example, the consensus network A11, the consensus network A22, or the consensus network A32). The P2P network may use a P2P protocol. The P2P protocol is an application layer protocol run over a transmission control protocol (TCP) protocol. Any device, such as a server or a terminal, may be added to a distributed system to become a blockchain node. Each blockchain node may include a hardware layer, an intermediate layer, an operating system layer, and an application layer.

In some embodiments, for any role (for example, an entity object such as any personal user, any enterprise, or any institution) accessing the blockchain network, a service node in the service network matching an identity of the role may be configured through the target consensus node in the target network. For example, when the service network A21 is the foregoing bill chain network, a service node (for example, a node corresponding to a bill issuance service provider) may be configured in the service network A21 shown in FIG. 1 for a bill issuance user (for example, an identity of the role is a user requesting to execute a first task that is a bill issuance task) to access the bill chain network through the service network A21.

When the consensus network A11 is used as the foregoing target network, a consensus node (for example, the foregoing target consensus node, where the target consensus node may be the consensus node 10a shown in FIG. 1) located in the target network may provide a registration service and an authorization service for a corresponding role (or a corresponding object) accessing the target network through a target chain entrance (for example, a chain entrance corresponding to the target network), thereby performing identity management and authority management in the target network on the corresponding role (for example, the corresponding object) to access the blockchain network (for example, the target network, the first network, the second network, or the target subnetwork). In addition, the target consensus nodes located in the target network may be further configured to perform data management on relevant metadata information in the blockchain system, for example, may manage and update a contract template on the target main chain (the contract template on the target main chain may include a management contract template of a smart contract deployed on the target main chain and an application contract template of a smart contract deployed on the second main chain), a bill template recorded on the target main chain, a tax calculation rule associated with the bill template, and the like, and control access traffic at a chain entrance corresponding to the first main chain, a quantity of consensus nodes on chains participating in consensus reaching, and the like.

For example, when deploying a smart contract corresponding to a second service on the second main chain, in a case of accessing the second network through the chain entrance (for example, the second chain entrance) corresponding to the second main chain, a developer and a taxation service participant may further read, based on a contract template reading method in a cross-chain reading contract on the second main chain, an application contract template corresponding to the second service from a target main chain indicated by the contract template reading method, to deploy the smart contract corresponding to the second service on the second main chain based on the read application contract template. When executing the second service on the second main chain subsequently, the taxation service participant may execute the corresponding second service by using the deployed smart contract corresponding to the second service.

In some embodiments, for ease of understanding, the foregoing service network performing data chaining interaction with the first network may be collectively referred to as a first service network based on the foregoing transaction chaining relationship, the foregoing service network performing data chaining interaction with the second network may be collectively referred to as a second service network based on the foregoing transaction chaining relationship, and the foregoing service network performing data chaining interaction with the target subnetwork may be collectively referred to as a third service network based on the foregoing transaction chaining relationship. In some embodiments, a service object performing data exchanging with the first service network may be referred to as a first service object, a service object performing data exchanging with the second service network may be referred to as a second service object, and a service object performing data exchanging with the third service network may be referred to as a third service object.

When the consensus network A22 is used as the first network, a consensus node (for example, the first consensus node, where the first consensus node may be the consensus node 11b shown in FIG. 1) located in the first network may be configured to execute a first service requested by a first service object through a service node in the first service network. The first service herein may include, but is not limited to, a bill service associated with the foregoing electronic bill. The bill service herein may include electronic bill-related services such as an electronic bill issuance service (for example, the foregoing bill issuance service), an electronic bill circulation service, an electronic bill red-ink offset service, and an electronic bill archiving service.

In addition, when the consensus network A32 is used as the second network, a consensus node (for example, the second consensus node, where the second consensus node may be the consensus node 12b shown in FIG. 1) located in the second network may be configured to provide a second service (for example, a credit investigation service, a crediting service, an entry and exit loss service, an enterprise qualification service, a social service, a credit purchase service, a tax refund service, or a lottery service) associated with the first service. The second consensus node may be configured to execute a second service requested by a second service object through a service node in the second service network.

By analogy, further, when the consensus network A42 is used as the target subnetwork, a consensus node (for example, the sub-consensus node, where the sub-consensus node may be the sub-consensus node 13b shown in FIG. 1) located in the target subnetwork may be configured to execute a target sub-service (for example, an audit service and a risk control and management service) associated with the foregoing first service and another target sub-service (for example, a data statistical analysis service) associated with the foregoing second service. In some embodiments, the target sub-service associated with the foregoing first service and the other target sub-services associated with the foregoing second service may be collectively referred to as the foregoing third services. The sub-consensus node in the target subnetwork may be configured to execute a third service requested by a third service object through a service node in the third service network.

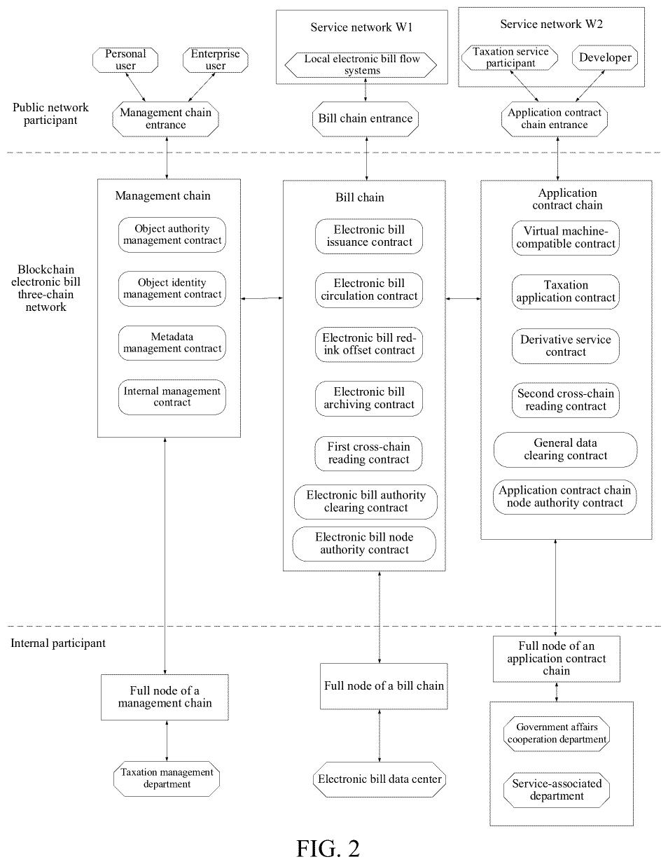

Referring to FIG. 2, FIG. 2 is a schematic diagram of a scenario of a blockchain electronic bill platform based on a multi-blockchain according to some embodiments. The blockchain electronic bill platform may be a service platform in the blockchain system. In the blockchain electronic bill platform, hybridity of data storage on a chain can be reduced through the blockchain electronic bill three-chain network shown in FIG. 2. As shown in FIG. 2, a management chain, a bill chain, and an application contract chain are deployed in the blockchain electronic bill three-chain network.

The management chain herein may be the foregoing target main chain, the bill chain herein may be the foregoing first main chain, and the application contract chain herein may be the foregoing second main chain. In this case, a first service network associated with the first main chain may be a service network W1 shown in FIG. 2, and a second service network associated with the second main chain may be a service network W2 shown in FIG. 2.

In a service scenario in which a blockchain is circulated as blockchain electronic bill core data, functional characteristics independently executing different services may be provided for the entire blockchain electronic bill platform through mutual cooperation between the management chain, the bill chain, and the application contract chain, and a secure and efficient service flow system may be constructed on the premise of the mutual cooperation between the three chains. Using an example in which the multi-chain system is a three-chain system, in the three-chain system, the management chain, the bill chain, and the application contract chain are all independently built. A consensus node configured to maintain the management chain is different from a consensus node configured to maintain the bill chain, and is also different from a consensus node configured to maintain the application contract chain.

As shown in FIG. 2, the management chain deployed in the blockchain electronic bill three-chain network is independent of the bill chain and the application contract chain. For example, the three blockchains that are independently built are independent of each other. However, the three blockchains that are independently built may exchange data across chains. For example, cross-chain interaction may be performed between the three chains. For example, in a case that a first cross-chain reading contract is deployed on the bill chain as shown in FIG. 2, a consensus node (for example, the foregoing first consensus node) participating in maintaining the bill chain may determine service processing authority of the first service object (for example, a service object corresponding to a service node in the service network W1) by reading service processing authority verification information on the management chain across chains based on the first cross-chain reading contract. In another example, in a case that a second cross-chain reading contract is deployed on the application contract chain as shown in FIG. 2, a consensus node (for example, the foregoing second consensus node) participating in maintaining the application contract chain may determine service processing authority of the second service object (for example, a service object corresponding to a service node in the service network W2) by reading service processing authority verification information on the management chain across chains based on the second cross-chain reading contract.

For example, the management chain herein may be configured to provide a management functional characteristic for the entire blockchain electronic bill platform. The bill chain herein may provide functional characteristics of bill services (for example, the foregoing first service) with different service processing authority types for the entire blockchain electronic bill platform. In some embodiments, to ensure security and independence of an electronic bill written into the bill chain, some embodiments propose that derivative services (for example, the second service) that are more standardized, flexible, and functionally complete may be provided through another blockchain (for example, the application contract chain shown in FIG. 2) independent of the management chain and the bill chain. For example, the application contract chain herein may provide, for the entire blockchain electronic bill platform, a functional characteristic of carrying out a derivative service based on core data in an electronic bill.

Using an example in which a consensus network (for example, the foregoing management chain network) on which the management chain is located is the consensus network A11 shown in FIG. 1, a consensus node participating in maintaining the management chain may be the foregoing management consensus node. As shown in FIG. 2, a plurality of smart contracts are deployed on the management chain. The smart contracts may be run on the management consensus node. The plurality of smart contracts herein may include an object authority management contract, an object identity management contract, a metadata management contract, and an internal management contract shown in FIG. 2. The smart contracts deployed on the management chain are determined by internal participants (for example, a taxation management department) shown in FIG. 2 respectively based on corresponding management contract templates deployed on their chains (for example, the management chain).

In addition, a global management information contract configured for performing information synchronization on global configuration information (for example, taxation metadata information, chain configuration information, and published data information) on blockchains involved in the blockchain system may be further deployed on the management chain. In addition, in the foregoing blockchain system, a global information cross-chain contract associated with the global management information contract may be synchronously deployed on both the bill chain and the application contract chain. A service node deployed in the service network W1 and a service node deployed in the service network W2 may obtain, through the global information cross-chain contract deployed on the blockchain, global configuration information published on the management chain.

The taxation management department shown in FIG. 2 may directly obtain data from the management chain through a full node of the management chain node (for example, may directly obtain full ledger data corresponding to the management chain). However, it is difficult for all other service nodes in the blockchain system other than the full node of the management chain to directly obtain the data on the management chain. To synchronize the data on the management chain to the other service nodes (for example, a service node in the service network W1 shown in FIG. 2) in the blockchain system, the foregoing global management information contract may be deployed on the management chain. The taxation management department writes, through the management consensus node on the management chain, global configuration information (for example, the taxation metadata information, the chain configuration information, and the published data information) to be synchronized into the global management information contract. A cross-chain relay in the three-chain system further relays and writes latest information written in the global management information contract on the management chain to global information cross-chain contracts on the bill chain, the application contract chain, and each subchain. A service node deployed in the service network W1 may obtain, through the global information cross-chain contract deployed on the bill chain, the global configuration information published on the management chain. Similarly, a service node deployed in the service network W2 may also obtain, through the global information cross-chain contract deployed on the application contract chain, the global configuration information published on the management chain.

The foregoing taxation management department may exercise management responsibilities through the management consensus node deployed in the management chain network. For example, the management responsibilities herein may include managing internal information of a government affairs department (for example, information about internal personnel of the taxation management department), managing a service logic rule for an overall service (for example, a derivative service contract run on the application contract chain for executing service logic of a derivative service), managing metadata information (for example, access traffic at chain entrances in the three-chain system) of the overall service, performing identity management and authority management on a participant (for example, a service object such as a personal user, an enterprise user, or a taxation service participant) of the overall service, and so on. In the blockchain network corresponding to the overall service, the management chain maintained by the management consensus node is a blockchain that is stabler and has a smallest data scale, but has highest security.

In addition, using an example in which a consensus network (for example, the foregoing bill chain network) on which the bill chain shown in FIG. 2 is located is the consensus network A22 shown in FIG. 1, a consensus node participating in maintaining the bill chain may be the foregoing first consensus node. As shown in FIG. 2, a plurality of smart contracts are deployed on the bill chain. The smart contracts may be run on the first consensus node. The plurality of smart contracts herein may include an electronic bill issuance contract, an electronic bill circulation contract, an electronic bill red-ink offset contract, an electronic bill archiving contract, a first cross-chain reading contract, an electronic bill authority clearing contract, and an electronic bill node authority contract shown in FIG. 2. Similarly, the smart contracts deployed on the bill chain are determined by an internal participant (for example, a taxation department associated with an electronic bill data center) shown in FIG. 2 based on a corresponding bill service contract template deployed on the management chain.

When a service node deployed in the first service network shown in FIG. 2 and a service node deployed in the second service network shown in FIG. 2 are configured to perform data clearing with the bill chain (for example, the first main chain), the first consensus node on the first main chain may perform, through a node authority contract (for example, the electronic bill node authority contract shown in FIG. 2) deployed on the bill chain, verification on node identities and node authority of service nodes originating from different service networks (for example, the service node originating from the first service network and the service node originating from the second service network) and may provide, based on the node identities and the node authority obtained through the verification, data clearing content in different forms for the service nodes originating from the different service networks. For the first consensus node, in some embodiments, when clearing transaction requests originating from different service networks are obtained through a bill chain entrance, service nodes initiating the clearing transaction requests are collectively referred to as service clearing nodes. In this case, after identity authority verification is performed on the service clearing nodes through the foregoing node authority contract (for example, the electronic bill node authority contract shown in FIG. 2), a service clearing node originating in the first service network may be referred to as a first-type clearing node (for example, a clearing node of a non-cross-chain type). In addition, node authority of the first-type clearing node is referred to as first-type clearing authority (for example, clearing authority of a non-cross-chain type). An electronic bill on the bill chain may be returned to the first-type clearing node having the first-type clearing authority, and ledger data and contract data that are associated with the electronic bill may be also returned, and a sub-ledger corresponding to the ledger data may be recovered on the first-type clearing node based on the electronic bill, the ledger data, and the contract data that are received.

In addition, in some embodiments, a service clearing node originating in the second service network may be referred to as a second-type clearing node (for example, a clearing node of a cross-chain type). In addition, node authority of the second-type clearing node is referred to as second-type clearing authority (for example, clearing authority of a cross-chain type). Core data of an electronic bill on the bill chain may be returned to the second-type clearing node with the second-type clearing authority, and the second-type clearing node may further transmit a transaction chaining request for the second service to the second consensus node on the second main chain based on the core data of the cleared electronic bill.

A first consensus node deployed in the bill chain network may maintain service logic of an electronic bill in a full life cycle through the bill chain, for example, may manage, through the bill chain, full life cycles of all issued electronic bills. For example, a full life cycle of an electronic bill herein includes issuance of the electronic bill, circulation of the electronic bill, reimbursement of the electronic bill, and the like. In the blockchain network corresponding to the overall service, the bill chain maintained by the first consensus node features high performance and low latency.

Using an example in which a consensus network (for example, the foregoing application contract chain network) on which the application contract chain is located is the consensus network A32 shown in FIG. 1, a consensus node participating in maintaining the application contract chain may be the foregoing second consensus node. As shown in FIG. 2, a plurality of smart contracts are deployed on the application contract chain. The smart contracts may be run on the second consensus node. The plurality of smart contracts herein may include a virtual machine-compatible contract, an open contract deployment contract, a derivative service contract, a second cross-chain reading contract, a data clearing contract, and an application contract chain node authority contract shown in FIG. 2.

A second consensus node deployed in the application contract chain network may bear, through the application contract chain, a derivative service corresponding to a changeable bill service. For example, the derivative service herein may include the foregoing credit investigation service, the foregoing qualification identification service, and the like. In the blockchain network corresponding to the overall service, the application contract chain maintained by the second consensus node may support a government affairs cooperation department and a consortium chain partner (for example, a service-associated department shown in shown in FIG. 2) shown in FIG. 2 and indirectly invoke the second cross-chain reading contract based on a taxation application contract (the open contract deployment contract) shown in FIG. 2, to use an application contract template read from the management chain across chains to develop a smart contract (for example, the derivative service contract shown in FIG. 2) related to the derivative service. In addition, the derivative service contract may be deployed on the application contract chain after being reviewed by the taxation management department. The smart contracts deployed on the application contract chain may be flexibly upgraded and changed based on a virtual machine-compatible contract. In the blockchain network corresponding to the overall service, the second consensus node may implement cross-chain interaction based on the second cross-chain reading contract on the application contract chain. For example, the second consensus node may also read the foregoing core data from the bill chain based on the second cross-chain reading contract to execute a derivative service. It means that the application contract chain maintained by the first consensus node has the highest openness compared with the management chain and the bill chain, supports complex smart contract logic, has a large number of participants, changes constantly dynamically, and has performance lower than that of the bill chain.

Since a service node deployed in the second service network may transmit a transaction clearing request to the first consensus node across chains through the bill chain entrance, core data in an electronic bill related to the service node (for example, the second-type clearing node) in the second service network on the bill chain may be returned to the second-type clearing node as clearing response information when the first consensus node performs identity authority verification on the service node originating from the second service network. The core data herein is partial bill information in the electronic bill visible to a second service object corresponding to the second-type clearing node. When the second-type clearing node provides a transaction chaining request to the second consensus node through an application contract chain entrance, the second-type clearing node may write core data cleared by and visible to the second-type clearing node into the transaction chaining request, and the second consensus node can match, when subsequently reading, from the bill chain based on the second cross-chain reading contract, core data of an electronic bill associated with the second-type clearing node, the core data with core data read in a different form, and may ensure reliability of executing the second service (for example, a derivative service corresponding to the foregoing bill service) on the application contract chain in a case that the two pieces of data are successfully matched.

For a service node in the service network W2, the service node in the service network W2 has a plurality of data clearing functions. For example, the plurality of data clearing functions herein means that the service node in the service network W2 may have a function of transmitting a clearing transaction request (for example, the first clearing transaction request) to the bill chain through the bill chain entrance, to clear service data related to the service node, and may also have a function of initiating another clearing transaction request (for example, the second clearing transaction request) to the application contract chain directly through the application contract chain entrance to clear the service data, ledger data, and contract data related to the service node. In view of the above, for a case in which the first main chain is the bill chain, and the second main chain is the application contract chain, when a service node in the service network W2 is configured to initiate a clearing transaction request (for example, the first clearing transaction request) to the first main chain, the service node in the service network W2 may be determined as the foregoing second-type clearing node. In this case, the second-type clearing node may initiate a transaction chaining request for executing the second service to the application contract chain based on contract data related to the second-type clearing node and cleared by the second-type clearing node from the bill chain.

In addition, for a case in which the first main chain is the bill chain, and the second main chain is the application contract chain, initiating, by the service node in the service network W2, another clearing transaction request (for example, the second clearing transaction request) to the application contract chain through the application contract chain entrance, to obtain service data, ledger data, and contract data related to the service node from the application contract chain, reference may be made to descriptions of initiating, by the service node in the service network W1, a data clearing request to the bill chain through the bill chain entrance, to obtain service data, ledger data, and contract data related to the service node.

When the bill chain involved in some embodiments is a second main chain, and the application contract chain is a first main chain, a first service network associated with the first main chain may be the service network W2 shown in FIG. 2, and a second service network associated with the second main chain may be the service network W1 shown in FIG. 2. Types of the first main chain and the second main chain are not limited.

In the blockchain electronic bill three-chain network shown in FIG. 2, a consensus algorithm used by the management chain is different from a consensus algorithm used by the bill chain and is also different from a consensus algorithm used by the application contract chain.

(1.1) a consensus algorithm associated with the management chain is an instant deterministic consensus algorithm. For example, the instant deterministic consensus algorithm herein may be a practical Byzantine fault tolerance (PBFT) consensus algorithm. A state of a to-be-chained proposal block may be immediately determined based on the PBFT consensus algorithm. The management chain is a blockchain in the foregoing management chain network. In a consensus node (for example, the foregoing management consensus node) in the management chain network, a taxation management department shown in FIG. 2 may participate in management.

An internal participant associated with the management chain may be the taxation management department shown in FIG. 2. For example, when the taxation management department accesses the management chain as an internal participant, some internal states of the taxation management department may be managed based on an internal management contract on the management chain. For example, personnel in the taxation management department can be managed. For example, taxation management personnel, taxation development personnel, taxation audit personnel, and the like may be configured in the personnel of the taxation management department. In addition, when the taxation management department accesses the management chain as an internal participant, some parameters in the three-chain system may also be managed based on the internal management contract on the management chain. For example, an access traffic parameter corresponding to access traffic at the bill chain entrance shown in FIG. 2 may be limited based on the internal management contract. For example, access traffic at the bill chain entrance within some time periods may be controlled not greater than an access traffic threshold based on a time-sharing access mechanism. In another example, when the taxation management department accesses the management chain as an internal participant, a node count parameter corresponding to a quantity of consensus nodes on chains participating in consensus reaching may be limited based on the internal management contract on the management chain.

(1.2) A consensus algorithm associated with the bill chain is another instant deterministic consensus algorithm. For example, the instant deterministic consensus algorithm herein may be a tower Byzantine fault tolerance (TBFT) consensus algorithm. The TBFT consensus algorithm is a Byzantine fault tolerance algorithm that can guarantee secure running of the entire bill chain network system in a case that a quantity of Byzantine nodes (for example, a quantity of evil nodes in the bill chain network) is less than ⅓ of a total quantity of nodes in the bill chain network. The foregoing taxation management department may participate in management on a consensus node located in the bill chain network. For example, taxation personnel in the taxation management department may control a quantity of consensus nodes in the bill chain network based on an internal management contract in the foregoing management chain. In another example, a taxation bureau terminal corresponding to taxation personnel in the taxation management department may participate in forming the bill chain network.

A difference between the foregoing TBFT consensus algorithm and the PBFT consensus algorithm is that, in the PBFT consensus algorithm, there is a fixed leader node (for example, a primary node) configured to package a transaction in a transaction pool, and when the leader node fails, the leader node is replaced by using a view-change sub-protocol (for example, a primary node switching sub-protocol). However, in the TBFT consensus algorithm, the leader node is rotated based on a rotation mechanism. For example, when a current node is used as the leader node, each time X blocks are submitted (a value of X can be configured), the leader node is automatically rotated to a next node. The consensus nodes in the bill chain network corresponding to the bill chain may be configured to continuously produce blocks.

(1.3) A consensus algorithm associated with the application contract chain is another instant deterministic consensus algorithm. For example, the instant deterministic consensus algorithm herein may be a proof-of-stake (POS) consensus algorithm. Network security of the application contract chain network on which the application contract chain is located can be maintained based on the POS consensus algorithm. In addition, a state of a to-be-chained proposal block can be determined immediately based on the POS consensus algorithm. The taxation management department and the government affairs cooperation department shown in FIG. 2, a large-scale participant institution (for example, a large-scale enterprise in the foregoing consortium chain, where the large-scale enterprise is the service-associated department shown in FIG. 2), and the like jointly participate in management on the consensus node in the application contract chain network. For example, taxation personnel in the taxation management department (for example, a taxation service participant shown in FIG. 2) may read, across chains through a consensus node in the application contract chain network, bill information of an electronic bill written onto the foregoing bill chain, to execute a derivative service associated with the foregoing bill service based on the bill information read across chains. For example, qualification identification or credit investigation identification may be performed, based on bill information read across chains, on a bill issuance enterprise requesting bill issuance, to obtain qualification data or credit investigation data of the bill issuance enterprise. As shown in FIG. 2, when accessing the application contract chain network through the application contract chain entrance shown in FIG. 2, a taxation service participant herein may invoke a second cross-chain reading contract on the application contract chain shown in FIG. 2 to read, from the bill chain shown in FIG. 2, core data in an electronic bill requested based on a derivative service, to use the read core data to carry out the corresponding derivative service on the application contract chain.

In some embodiments, directly transferring a large number of electronic bills generated on the bill chain to the application contract chain across chains may be avoided, and partially-authorized-to-be-visible bill information (for example, the foregoing core data) in the electronic bills generated on the bill chain is transferred across chains to the application contract chain. Privacy and security of the electronic bills recorded on the bill chain can be ensured from the root.

In view of the above, for the taxation service participant requesting to access the foregoing application contract chain, different core data (for example, bill information with different data content may be obtained from the foregoing electronic bills) may be read from the bill chain across chains according to different requested derivative services.

For the smart contracts in the blockchain electronic bill three-chain network, there are the following differences:

(2.1) A language smart contract engine may be supported on the management chain shown in FIG. 2. The foregoing management consensus node may deploy a language smart contract on the management chain through the language smart contract engine. For example, an object authority management contract, an object identity management contract, a metadata management contract, and an internal management contract shown in FIG. 2 may be deployed on the management chain. The smart contracts can be developed and managed by taxation management personnel in the taxation management department.

(2.2) Smart contracts with bill service logic are built in the bill chain shown in FIG. 2. The smart contracts (for example, an electronic bill issuance contract, an electronic bill circulation contract, an electronic bill red-ink offset contract, an electronic bill archiving contract, and a first cross-chain reading contract shown in FIG. 2) may be upgraded with the update of the bill service. For example, in some embodiments, the bill service logic in the electronic bill issuance contract may be updated based on metadata information read from the management chain, and further, the foregoing bill service may be updated and processed according to the updated electronic bill issuance contract. The bill chain may not support an independent smart contract engine, and may not support deploying another contract unrelated to the bill service on the bill chain. The bill chain may only run service logic related to the electronic bill, and may not affected by another smart contract, and running of the bill chain may be more independent, stable, and attack-resistant.

(2.3) The application contract chain supports a multi-language, Turing-complete, developer-oriented smart contract. For example, as shown in FIG. 2, when a developer accesses the application contract chain through an application contract chain entrance, compatibility with a mainstream EVM virtual machine may be reached based on a virtual machine-compatible contract, and various new service contracts may be deployed on the virtual machine with which compatibility is reached. For example, a derivative service contract associated with a derivative service (for example, the foregoing lottery service) may be deployed on the application contract chain. In another example, a derivative application contract associated with another derivative service (for example, the foregoing tax refund service) may be deployed on the application contract chain.

As shown in FIG. 2 above, in the blockchain electronic bill three-chain network, the cross-chain reading contract is not deployed on the management chain. The management chain may not have a cross-chain capability. Because the cross-chain reading contract is deployed on both the bill chain and the application contract chain shown in FIG. 2, the bill chain and the application contract chain have the cross-chain capability.

The consensus node (for example, the foregoing first consensus node) associated with the bill chain may read partial management chain information from the management chain based on the first cross-chain reading contract shown in FIG. 2. For example, registration data information for storing an authorized object at the bill chain entrance may be read from the management chain. In another example, the service processing authority verification information (for example, the first service processing authority verification information) configured for confirming the service processing authority of the service object may be read from the management chain, and bill key information configured for issuing an electronic bill (for example, an electronic invoice) may also be read from the management chain.

The bill key information herein refers to authorized-to-be-visible auxiliary metadata information (for example, an updated electronic bill template recorded in management) read from the management chain based on an electronic bill service in the bill service when it is determined that the service processing authority is of a bill issuance authority type.

In addition, a consensus node (for example, the foregoing second consensus node) associated with the application contract chain may read partial management chain information from the management chain based on the second cross-chain reading contract shown in FIG. 2. For example, a service participation permission credential of an authorized object stored at the application contract chain entrance shown in FIG. 2 may be read from the management chain, or service processing authority verification information (for example, the second service processing authority verification information) for performing access authentication on a service object requesting execution of a derivative service may be read from the management chain, or partial bill chain information may be read from the bill chain (for example, partially-authorized-to-be-visible bill information in an electronic bill associated with the derivative service is read from the bill chain). Both the partial management chain information and the partial bill chain information read from the management chain by the second consensus node may be configured for carrying out the foregoing derivative services.

As shown in FIG. 2, in the blockchain electronic bill three-chain network, public network participants associated with the management chain may be a personal user and an enterprise user shown in FIG. 2. Likewise, as shown in FIG. 2, public network participants associated with the bill chain may be local electronic bill data flow systems shown in FIG. 2. A service network corresponding to the local electronic bill data flow system herein may be the foregoing first service network (for example, the service network W1 shown in FIG. 2). For example, for local electronic bill service issuance systems (for example, local taxation bureau systems), first service objects corresponding to service nodes in the first service network may include, but are not limited to, electronic bill issuance service providers, finance and taxation-related systems of large-scale enterprises, and the like. Likewise, as shown in FIG. 2, public network participants associated with the application contract chain may be a taxation service participant and a developer shown in FIG. 2. For example, the taxation service participant and the developer herein may be second service objects corresponding to service nodes in the foregoing second service network (for example, the service network W2 shown in FIG. 2).

(3.1) a chain entrance (for example, the target chain entrance) associated with the management chain may be a management chain entrance shown in FIG. 2. When serving as public network participants, the personal user (for example, a user A) and the enterprise user (for example, an enterprise B) shown in FIG. 2 and the like may access the management chain through the management chain entrance, and may further perform services, such as identity registration and identity authorization, through the management chain. (3.2) A chain entrance (for example, the first chain entrance) associated with the bill chain may be a bill chain entrance shown in FIG. 2. When serving as public network participants, the local electronic bill data flow systems (for example, large-scale enterprise users) shown in FIG. 2 and the like may access the bill chain through the bill chain entrance, and may further perform an electronic bill issuance service, an electronic bill circulation service, an electronic bill red-ink offset service, and an electronic bill archiving service through the bill chain. (3.3) A chain entrance (for example, the second chain entrance) associated with the application contract chain may be an application contract chain entrance shown in FIG. 2. When serving as public network participants, the taxation service participant and developer shown in FIG. 2 may access the application contract chain through the application contract chain entrance, and may further deploy derivative service contracts on the application contract chain, to execute electronic bill-related derivative services based on the deployed derivative service contracts. The developer shown in FIG. 2 may also deploy, in a case of accessing the application contract chain, a derivative service contract corresponding to another derivative service (or an exploratory service) on the application contract chain. A quantity of derivative service contracts deployed on the application contract chain is not limited herein.

The management chain entrance shown in FIG. 2 may be a taxation management department entrance. Through the taxation management department entrance, identity identification and service guidance may be performed on individuals, legal persons, entities, and the like that are to access the management chain.

The bill chain entrance shown in FIG. 2 may be an electronic bill service entrance. Transaction data of an electronic bill whose issuance is requested by a service object (for example, a service object, where the service object may be the foregoing enterprise B) may be received through the electronic bill service entrance. When receiving transaction data submitted by the enterprise B through the electronic bill service entrance, the first consensus node may further verify, through the electronic bill service entrance, whether an access identity and access authority of a data transmitter (for example, the enterprise B serving as a service object) of the transaction data meet state requirements of an identity authority contract in the management chain. When the verification succeeds, it may be determined that the enterprise B serving as the service object is an authorized object, and service processing authority of the enterprise B serving as an authorized object may be determined by reading the foregoing first service processing authority verification information from the management chain based on the first cross-chain reading contract on the bill chain. Based on the first service processing authority verification information, it may be further determined whether the service processing authority of the enterprise B serving as an authorized object meets a state requirement of an object authority management contract in the management chain.

For example, the first consensus node may determine, through the electronic bill service entrance, whether an access identity and access authority of the data transmitter (for example, the enterprise B) meet contract state requirements of an object identity management contract and an internal management contract in the management chain and may determine, when determining that the contract state requirements of the object identity management contract and the internal management contract in the management chain are met, that access authentication has been completed on the data transmitter (for example, the enterprise B) to access the bill chain. In view of the above, registration data information of authorized objects obtained from the management chain is stored in the bill chain entrance shown in FIG. 2. The registration data information herein may include, but is not limited to, object access identity registration information and object access authority registration information. For example, the object access identity information herein may be configured for identifying whether a service object (for example, the enterprise B) currently requesting to access the bill chain is an authorized object. The object access authority registration information herein includes a chain access count threshold (for example, a maximum concurrent request cumulative count) configured by the management consensus node for the electronic bill service entrance of the bill chain based on the internal management contract. The first service processing authority verification information may represent which bill service contracts on the bill chain the service object (for example, the enterprise B) serving as an authorized object has authority to access.

The application contract chain entrance shown in FIG. 2 may be a taxation derivative service entrance. A derivative service that a service object (for example, the second service object, where the second service object may be the taxation service participant shown in FIG. 2) requests to participate in and that is associated with the bill service may be received through the taxation derivative service entrance. The taxation service participant and the developer shown in FIG. 2 may perform, through the application contract chain entrance, after obtaining a service participation permission credential of an authorized object issued by the taxation management department, verification on a service participation permission credential submitted by the second service object (for example, the taxation service participant or the developer) and may allow, when the verification succeeds, the second service object to access the application contract chain to execute a derivative service associated with the foregoing bill service on the application contract chain.

As shown in FIG. 2, an internal participant participating in maintaining the management chain may be the taxation management department shown in FIG. 2. The taxation management department herein is configured to configure and manage an internal state parameter on the management chain, may also be configured to change and chain the foregoing metadata information (for example, taxation metadata) (for example, may update an electronic bill template and update a tax calculation rule), and may manage identities and authority of various service participants maintained on the management chain (for example, freeze an bill issuance qualification of an enterprise, and limit a bill issuance amount of an enterprise). In addition, as shown in FIG. 2, when management personnel in the taxation management department herein serve as a service synchronization object, the management personnel in the taxation management department may also directly perform data synchronization and exchanging with a ledger interface on the management chain through a full node of the management chain shown in FIG. 2 without interacting with a contract on the management chain. For example, the taxation management department may fully synchronize ledger data and contract data of the entire management chain through the full node of the management chain. The management personnel (for example, the service synchronization object) in the taxation management department corresponding to the full node of the management chain may have completely transparent data access authority to transactions in blocks on the management chain.

As shown in FIG. 2, an internal participant participating in maintaining the bill chain may be an electronic bill data center shown in FIG. 2. The electronic bill data center herein may be an electronic invoice data center. The electronic bill data center (for example, the electronic invoice data center) may be configured to perform off-chain backup, statistics, data analysis, a review, and the like on massive ledger data (for example, an electronic bill flow generated based on a real-time bill service flow, and the like) recorded on the bill chain. Through the electronic bill data center, a time-sharing bill issuance count may be counted, a risk bill (for example, a risk invoice) and a risk enterprise may be determined based on the counted time-sharing bill issuance count, and data analysis and the like may also be performed on relevant financial and economic data. In addition, as shown in FIG. 2, when relevant personnel in the electronic bill data center herein serve as a service synchronization object, the relevant personnel in the electronic bill data center may also directly perform data synchronization and exchanging with a ledger interface on the bill chain through a full node of the bill chain shown in FIG. 2 without interacting with a contract on the bill chain. For example, the relevant personnel in the electronic bill data center may fully synchronize ledger data and contract data of the entire bill chain through the full node of the bill chain. The relevant personnel (for example, the service synchronization object) in the electronic bill data center corresponding to the full node of the bill chain may have completely transparent data access authority to transactions in blocks on the bill chain.

As shown in FIG. 2, an internal participant participating in maintaining the application contract chain may be the government affairs cooperation department and the service-associated department shown in FIG. 2. The internal participant, other than the taxation management department, participating in maintaining the application contract chain and another department (for example, the foregoing government affairs cooperation department) and another participant (for example, the foregoing service-associated department) in the system consortium chain can all execute a corresponding derivative service based on a derivative service contract on the application contract chain in a case of accessing the application contract chain. In addition, as shown in FIG. 2, when relevant personnel in the government affairs cooperation department and the service-associated department herein serve as a service synchronization object, the relevant personnel in the government affairs cooperation department and the service-associated department may also directly perform data synchronization and exchanging with a ledger interface on the application contract chain through a full node of the application contract chain shown in FIG. 2 without interacting with a contract on the application contract chain. For example, the relevant personnel in the government affairs cooperation department and the service-associated department may fully synchronize ledger data and contract data of the entire application contract chain through the full node of the application contract chain. The relevant personnel (for example, the service synchronization object) in the government affairs cooperation department and the service-associated department corresponding to the full node of the application contract chain may have completely transparent data access authority to transactions in blocks on the application contract chain. With respect to the government affairs cooperation department and the service-associated department shown in FIG. 2, as taxation service participants access the application contract chain, the government affairs cooperation department and the service-associated department may be able to flexibly run various expendable derivative service in a cycle of supporting a complete smart contract statement, to ensure the flexibility of service changes without directly accessing core data of electronic bills on the bill chain, thereby ensuring data privacy and core data security on the bill chain. The second consensus node involved in some embodiments may read partially-authorized-to-be-visible bill chain data for a current derivative service on the bill chain based on a second cross-chain reading contract (for example, through a cross-chain reading method in the second cross-chain reading contract) on the application contract chain, for example, may read, from the bill chain, core data (the core data herein may be bill information in electronic bills involved in the foregoing electronic bill flow, and for a case in which the electronic bill is an electronic invoice, the bill chain data herein may be partially-authorized-to-be-visible invoice data) related to the current derivative service across chains, to ensure, based on the read core data, that a derivative service requested by the second service object may be carried out on the application contract chain.

In some embodiments, to improve data privacy of electronic bills belonging to the bill chain, the second consensus node may also request, through a chain identifier (for example, the chain identifier herein is a chain identifier corresponding to the bill chain) indicated by a cross-chain authorization method in the second cross-chain reading contract, the first consensus node corresponding to the bill chain to read, from the bill chain, an electronic bill (for example, an electronic bill issued by an enterprise C) associated with the derivative service and may return, in bill information of the read electronic bill, bill information associated with the derivative service to the second consensus node as the foregoing authorized-to-be-visible core data. In this case, the second consensus node cannot learn of other bill information that is in the electronic bill and that is not related to the derivative service, and further, cannot access another electronic bill (for example, an electronic bill issued by an enterprise D) that is on the bill chain and that is not related to the derivative service. Privacy security and reliability of bill data stored on the bill chain can be ensured.

The management chain shown in FIG. 2 is configured to process a management service flow with a small data volume and a constant status, and may be configured to perform internal management on some taxation data since openness of the entire management chain is low. However, the bill chain shown in FIG. 2 may be configured to process some real-time bill service flows whose data is frequently requested for a long time. The entire bill chain has high openness and may allow a relevant authority in a life cycle of an electronic bill itself to participate in a corresponding bill service, for example, may allow a consensus node corresponding to an agent service provider to issue an electronic bill for a user currently requesting bill issuance. In addition, for the application contract chain shown in FIG. 2, a data amount may not be limited, and frequency fluctuations of service changes are relatively large. Various cooperative services, derivative services, and exploratory services may be processed through the application contract chain. The application contract chain has the highest openness, and may run a smart contract deployed on the application contract chain by a participant authorized by the management chain, run an exploratory derivative service, and so on. In some embodiments, in consideration of that the application contract chain has high openness and flexibility of service changes, a smart contract built in the application contract chain may have more contract security restrictions during execution. For example, a quantity of contract execution operations may be limited (for example, for the derivative service contract shown in FIG. 2, which contract methods in the derivative service contract can be accessed by the current service object (for example, the second service object) may be limited), and a quantity of storage resources that may be consumed for accessing the derivative service contract and the like may be limited (for example, invocation of the smart contract on the application contract chain may consume a quantity of storage resourced).

The consensus node in the three-chain system involved in some embodiments may be an independent physical server, or may be a server cluster including a plurality of physical servers or a distributed system, or may be a cloud server providing cloud computing services, such as a cloud service, a cloud database, cloud computing, a cloud function, cloud storage, a network service, cloud communication, a middleware service, a domain name service, a security service, a CDN, big data, and an artificial intelligence platform.

When obtaining data, such as authorized access data information, registration data information, a service participation permission credential, and bill information in an electronic bill, of a service object (for example, the personal user or the enterprise user) across chains, the consensus node in some embodiments may display a prompt interface or a popup window. The prompt interface or popup window is configured to prompt the service object that the data, such as the registration data information, the service participation permission credential, and the bill information in the electronic bill, is currently collected. Execution of an operation related to data obtaining is started only after a confirm operation performed by the service object on the prompt interface or the popup window is received; otherwise, the execution is ended.

In addition, in some embodiments, service data (for example, bill issuance information, credit investigation information, tax refund information, and the like of a user, and information, such as entry and exit losses and an enterprise qualification, of an enterprise) of a service object, such as a user, an enterprise, and an institution, may be involved. When some embodiments are applied to a product or technology, a permission or an approval from a service object, such as a user, an enterprise, and an institution, may be obtained. In addition, collection, use, and processing of related data should comply with relevant laws, regulations, and standards of relevant countries and regions.

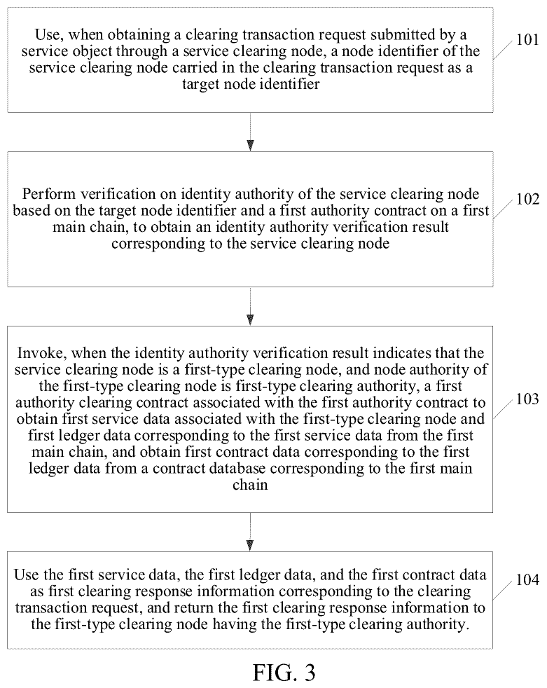

In the foregoing blockchain system, for a process of performing data clearing on a first main chain (for example, the bill chain) for service nodes originating from different service networks, reference may be made to the following embodiments corresponding to FIG. 3 to FIG. 9.

Referring to FIG. 3, FIG. 3 is a schematic diagram of a data processing method based on a multi-blockchain according to some embodiments. As shown in FIG. 3, the method may be performed by a first consensus node in the foregoing first network. For example, the first consensus node may be any consensus node in the consensus network A22 shown in FIG. 1. The method may include the following operation 101 to operation 104.

Operation 101: Use, when obtaining a clearing transaction request submitted by a service object through a service clearing node, a node identifier of the service clearing node carried in the clearing transaction request as a target node identifier.

For example, the service object involved in some embodiments includes a first service object associated with a first service network. The first service network herein is a service network associated with the first network. For example, a service node deployed in the first service network may exchange data with the first consensus node deployed in the first network. The data exchanging herein may include the foregoing data chaining interaction and may further include data clearing interaction.

The first network involved in some embodiments may be a consensus network in the foregoing blockchain electronic bill three-chain network. In addition, in some embodiments, the first network is deployed in a secure private cloud, and all consensus nodes in the first network in the private cloud run a blockchain consensus protocol based on the foregoing TBFT consensus algorithm. Access security between the consensus nodes in the first network can be ensured through a consensus mechanism corresponding to the foregoing blockchain consensus protocol.

However, for a public network participant (for example, the service object, such as a personal user and an enterprise user, shown in FIG. 2) in a public network, if the public network participant is to access the first network through a service network, preliminary access authentication (for example, identity verification and authority verification may be performed) may be first performed on the public network participant requesting to access the first network through the first chain entrance shown in FIG. 2, to ensure access security of a public network participant accessing the first network.

A request received by the first chain entrance may include a data clearing transaction request configured to request data clearing and a transaction chaining request configured to request transaction chaining. An example in which the request received by the first chain entrance is a data clearing transaction request is used herein, to describe a process of determining a service object initiating the data clearing transaction request as an authorized object.

In some embodiments, public network participants requesting to access the first network through service networks (for example, one or more of the first service network, the second service network, and the third service network) may be collectively referred to as service objects, and access authentication may be performed, through the foregoing first chain entrance, on the service objects originating from the service networks. To ensure access security of a public network participant requesting to access the first network, some embodiments may provide that before the foregoing operation 101 is performed, the first consensus node may perform preliminary access authentication in advance on the public network participant requesting to access the first network, to ensure reliability of a data clearing transaction request initiated by the public network participant. In some embodiments, service nodes originating from different service networks and configured to perform data clearing may be collectively referred to as service clearing nodes.

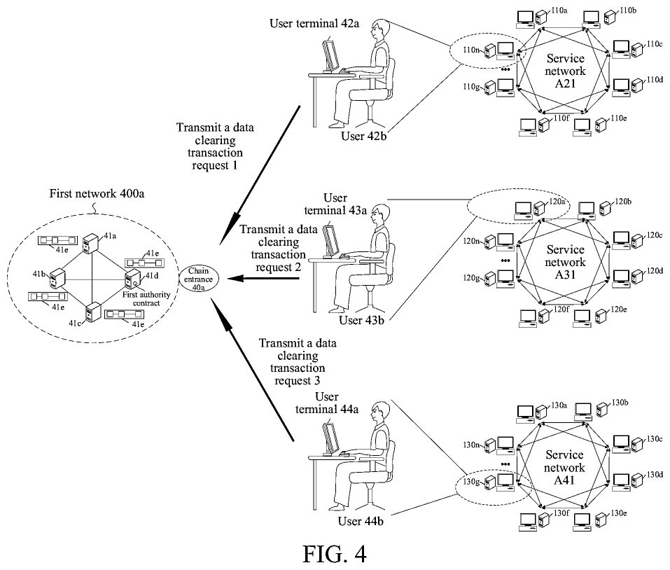

With reference to a plurality of service networks in the embodiment corresponding to FIG. 1, some embodiments provide a schematic diagram of a scenario in which service clearing nodes in the plurality of service networks exchange data with a first consensus node in a first network. Referring to FIG. 4, FIG. 4 is a schematic diagram of a scenario of obtaining a clearing transaction request through a first chain entrance according to some embodiments. For example, a first network 400a in FIG. 4 may be the consensus network A22 in the foregoing embodiment corresponding to FIG. 1. The consensus network A22 herein may be a consensus network in the foregoing blockchain electronic bill three-chain network, for example, a bill chain network corresponding to the foregoing bill chain. A service network A21 shown in FIG. 4 may be a first service network associated with the first network (for example, the consensus network A22) in the foregoing embodiment corresponding to FIG. 1. A service network A31 shown in FIG. 4 may be a second service network associated with the second network (for example, the consensus network A32) in the foregoing embodiment corresponding to FIG. 1. A service network A41 shown in FIG. 4 may be a third service network associated with the target subnetwork (for example, the sub-consensus network A42) in the foregoing embodiment corresponding to FIG. 1.

As shown in FIG. 4, consensus nodes deployed in the first network include a consensus node 41a, a consensus node 41b, a consensus node 41c, and a consensus node 41d shown in FIG. 4. For case of understanding, in some embodiments, a leader node that is configured to successively produce blocks and that is determined based on the TBFT consensus algorithm in the consensus network A22 may be used as the first consensus node. For example, the consensus node 41d deployed in the first network 400a shown in FIG. 4 may be used as the first consensus node. As shown in FIG. 4, a first authority contract is run on the first consensus node. In some embodiments, the first authority contract deployed on the first consensus nodes of the first network may be collectively referred to as the foregoing node authority contract.

To ensure security and isolation of on-chain data on the first main chain (for example, a first main chain 41e shown in FIG. 4) during data clearing, some embodiments provide that when data clearing is performed through the first consensus node (for example, a consensus node 41d shown in FIG. 4), node sources of the service clearing nodes currently initiating data clearing transaction requests may be determined through the first authority contract, and node types (for example, node identities) of the service clearing nodes may be intelligently divided according to different sources of the service clearing nodes. Different node authority may be configured according to the different node types, and different data may be cleared from the first main chain.

As shown in FIG. 4, the service clearing nodes currently initiating data clearing transaction requests may include a service node 110n originating from a service network A21, a service node 120a originating from a service network A31, and a service node 130g originating from a service network A41 shown in FIG. 4. As shown in FIG. 4, the service node 110n in the service network A21 may be a user terminal 42a shown in FIG. 4, and a service object initiating a data clearing transaction request 1 through the user terminal 42a may be a user 42b shown in FIG. 4. Likewise, as shown in FIG. 4, the service node 120a in the service network A31 may be a user terminal 43a shown in FIG. 4, and a service object initiating a data clearing transaction request 2 through the user terminal 43a may be a user 43b shown in FIG. 4. By analogy, as shown in FIG. 4, the service node 130g in the service network A41 may be a user terminal 44a shown in FIG. 4, and a service object initiating a data clearing transaction request 3 through the user terminal 44a may be a user 44b shown in FIG. 4.

A chain entrance 40a shown in FIG. 4 may be the first chain entrance corresponding to the first network (the first chain entrance herein may be an electronic invoice service entrance in the embodiment corresponding to FIG. 2). The first chain entrance has a chain access count threshold corresponding to the first main chain and authorized access data information stored therein. The authorized access data information is authorized access data information that is of an authorized object allowed to access the first main chain and that is obtained by the first consensus node from the target main chain. The authorized access data information therein is generated by a target consensus node based on object data information. The target consensus node is associated with the target main chain, and the object data information is submitted by the authorized object. The chain access count threshold represents a maximum concurrent request access count obtained through the first chain entrance. The target main chain herein may be another consensus network in the foregoing blockchain electronic bill three-chain network. For example, the target main chain herein may be the management chain in the foregoing embodiment corresponding to FIG. 2.

In some embodiments, the first consensus node increments, when obtaining, through the first chain entrance, a data clearing transaction request submitted by the service object through the service clearing node, a request access count of the first chain entrance based on the data clearing transaction request, to obtain an incremented request access count; obtains, when the incremented request access count does not reach the chain access count threshold, access request data information associated with the service object from the data clearing transaction request; performs, based on the authorized access data information, access authentication on the service object submitting the access request data information, to obtain an access authentication result of the service object; and determines, when the access authentication result indicates that the access request data information is consistent with access registration data information in the authorized access data information, the service object as the authorized object, and uses the data clearing transaction request submitted by the service object as the clearing transaction request.

As shown in FIG. 4, when the first consensus node (for example, the consensus node 41d) obtains, through the first chain entrance (for example, the chain entrance 40a), the data clearing transaction request 1 submitted by the user 42b (a service object) through the user terminal 42a, the data clearing transaction request 2 submitted by the user 43b (a service object) through the user terminal 43a, and the data clearing transaction request 3 submitted by the user 44b (a service object) through the user terminal 44a, the first consensus node may increment the request access count of the first chain entrance based on the data clearing transaction request 1, the data clearing transaction request 2, and the data clearing transaction request 3 currently obtained in sequence, to obtain the incremented request access count.

The user terminal 42a herein is a service clearing node that is in the service network A21 and that is configured to submit the data clearing transaction request 1, the user terminal 43a herein is a service clearing node that is in the service network A31 and that is configured to submit the data clearing transaction request 2, and the user terminal 44a herein is a service clearing node that is in the service network A41 and that is configured to submit the data clearing transaction request 3. In some embodiments, the user 42b submitting the data clearing transaction request 1, the user object 43b submitting the data clearing transaction request 2, and the user 44b submitting the data clearing transaction request 3 may be collectively referred to as the foregoing service objects.

When the incremented request access count does not reach the chain access count threshold, the first consensus node (for example, the consensus node 41d) may obtain access request data information associated with the service objects from the data clearing transaction requests.

The first consensus node may perform, based on authorized access data information of authorized objects stored in the first chain entrance, access authentication on the service objects submitting the access request data information, to obtain access authentication results of the service objects.

An example in which the chain entrance 40a shown in FIG. 4 obtains a data clearing transaction request (for example, the data clearing transaction request 1 shown in FIG. 4) is used herein to describe a process of performing access authentication on the user 42b through the chain entrance 40a. The first consensus node (for example, the consensus node 41d) may increment, when obtaining, through the first chain entrance (for example, the chain entrance 40a), the data clearing transaction request 1 submitted by the user 42b through the user terminal 42a, the request access count of the first chain entrance based on the currently obtained data clearing transaction request 1, to obtain the incremented request access count. For example, the current access request count of the first chain entrance is 100, and the access request count obtained after an increment by one is 101. The first consensus node (for example, the consensus node 41d) may obtain, when the incremented request access count (for example, 101) does not reach the chain access count threshold (for example, 120), access request data information associated with the user 42b from the data clearing transaction request 1. The first consensus node may perform, based on authorized access data information of authorized objects stored in the first chain entrance (for example, the chain entrance 40a), access authentication on the user 42b submitting the access request data information, to obtain an access authentication result of the user 42b.

When the access authentication result indicates that the access request data information is consistent with the access registration data information in the authorized access data information, the first consensus node (for example, the consensus node 41d) may determine the user 42b in FIG. 4 as an authorized object, and then may use the data request transaction request 1 submitted by the user 42b as a clearing transaction request. A node identifier of the service clearing node (for example, a node identifier of the user terminal 42a used as the service clearing node) carried in the clearing transaction request may be used as a target node identifier, for further performing the following operation 102.

The authorized access data information stored in the first chain entrance (for example, the chain entrance 40a) may carry public key information of the service object (for example, the user 42b). In addition, the data clearing transaction request 1 submitted by the user 42b may carry object signature information of the user 42b. The object signature information herein may be obtained after the user terminal 42a of the service clearing node performs, based on private key information of the service object (for example, the user 42b), signature addition on a first clearing transaction requested by the service object (for example, the user 42b). The private key information of the service object (for example, the user 42b) and the public key information of the service object (for example, the user 42b) form a key pair with each other. In addition, the private key information of the service object (for example, the user 42b) and the public key information of the service object (for example, the user 42b) are both configured by the target consensus node based on the object data information submitted by the service object (for example, the user 42b).

In some embodiments, the obtaining access request data information associated with the service object from the data clearing transaction request may be implemented through the following technical solution: obtaining the object signature information from the data clearing transaction request, and performing signature verification on the object signature information based on the public key information of the service object stored in the first chain entrance, to obtain a signature verification result; and obtaining, when the signature verification result indicates that the signature verification succeeds, the first clearing transaction carried in the data clearing transaction request, and using access data information corresponding to the first clearing transaction as the access request data information associated with the service object.

In some embodiments, a process in which the first consensus node obtains access request data information associated with the service object (for example, the user 42b) from the data clearing transaction request 1 may be implemented through the following technical solution: The first consensus node obtains the object signature information of the user 42b from the data clearing transaction request 1, and performs signature verification on the object signature information of the user 42b based on the public key information of the service object (for example, the user 42b) stored in the first chain entrance, to obtain a signature verification result. The first consensus node may obtain, when the signature verification result indicates that the signature verification succeeds, the first clearing transaction carried in the data clearing transaction request 1, and may use access data information (for example, an authorization code delivered by the target main chain for the first clearing transaction or a hash value of transaction data calculated by the first service node for the first clearing transaction) corresponding to the first clearing transaction as the access request data information associated with the service object.

In some embodiments, when the signature verification result indicates that the signature verification fails, the first consensus node may also determine the service object (for example, the user 42b) as an invalid object, and reject the data clearing transaction request 1 transmitted by the invalid object.

When determining that none of the incremented request access counts reaches the chain access count threshold, the first consensus node obtains object signature information of the service objects from the data clearing transaction request 1, the data clearing transaction request 2, and the data clearing transaction request 3 in sequence. For processes in which the first consensus node obtains object signature information of the user 43b and object signature information of the user 44b from the data clearing transaction request 2 and the data clearing transaction request 3, reference may be made to the descriptions of the process in which the object signature information of the user 42b is obtained from the data clearing transaction request 1.

The first chain entrance (for example, the chain entrance 40a) involved in some embodiments may perform traffic control based on data clearing transaction requests currently obtained in batches. For example, when the first consensus node (for example, the consensus node 41d) obtains, through the first chain entrance (for example, the chain entrance 40a), the data clearing transaction request 1 submitted by the user 42b through the user terminal 42a, the data clearing transaction request 2 submitted by the user 43b through the user terminal 43a, and the data clearing transaction request 3 submitted by the user 44b through the user terminal 44a, the first consensus node may increment the request access count of the first chain entrance based on the data clearing transaction request 1, the data clearing transaction request 2, and the data clearing transaction request 3 currently obtained in sequence, to obtain the incremented request access count. It is assumed that a request access count before the increment is 99, a request access count after the increment is 99+3=102, and the chain access count threshold corresponding to the first chain entrance is 100. When the incremented request access count reaches the chain access count threshold, the data clearing transaction request 1, the data clearing transaction request 2 when the incremented request access count reaches the chain access count threshold, and the data clearing transaction request 3 may be rejected in sequence, and access failure prompt information associated with the chain access count threshold may be returned to the user terminal 42a, the user terminal 43a, and the user terminal 44a shown in FIG. 4.

Operation 102: Perform verification on identity authority of the service clearing node based on the target node identifier and a first authority contract on the first main chain, to obtain an identity authority verification result corresponding to the service clearing node.

In some embodiments, the first consensus node may write the target node identifier into the first authority contract on the first main chain. The first consensus node may invoke a first identity verification method in the first authority contract to perform identity verification on the service clearing node having the target node identifier, to obtain an identity verification result. When the identity verification result indicates that a node identity of the service clearing node is of a first identity type, the first consensus node may use the service clearing node corresponding to the first identity type as the first-type clearing node, and invoke a first authority verification method in the first authority contract to perform authority verification on the service clearing node having the target node identifier, to obtain an authority verification result. When the authority verification result indicates that node authority of the service clearing node is the first-type clearing authority, the first consensus node may use the first-type clearing node having the first-type clearing authority as the identity authority verification result corresponding to the service clearing node.

To ensure security and isolation of on-chain data during data clearing, some embodiments provide that when data clearing is performed, node types of the service clearing nodes may be divided according to different sources of the service clearing nodes. Different node authority may be configured according to the different node types, and different data may be cleared from the first main chain according to the different node authority. For example, in some embodiments, a service clearing node originating from a first service network may be divided into a first-type clearing node, a service clearing node originating from a second service network may be divided into a second-type clearing node, and a service clearing node originating from a third service network may be divided into a third-type clearing node.

For example, for the service network A21, the service network A31, and the service network A41 in the embodiment corresponding to FIG. 4, corresponding node types (or node identities) may be configured, through a target consensus node on the target main chain in the multi-blockchain, for service nodes used by service objects in the service networks, and the configured node types (or node identities) of the service nodes may be synchronized to a node authority contract on the corresponding main chain.

For example, for the service network A21 associated with the first network, the service network A21 may be recorded as a first service network in the node authority contract (for example, the first authority contract shown in FIG. 4) run on the first consensus node, and node identifiers of service nodes configured to perform data clearing in the first service network may be synchronously recorded, and node identities and node authority may be configured for the node identifiers synchronously recorded onto the target consensus node.

When obtaining the data clearing transaction request 1 transmitted by the service node in the service network A21, the first consensus node may quickly determine, based on a target node identifier carried in the data clearing transaction request 1, through a target node identifier recorded in the first authority contract, that a node identity of the service node 110n (for example, the user terminal 42a shown in FIG. 4) in the first service network is of a first identity type. The user terminal 42a of the first identity type transmitting the data clearing transaction request 1 may be determined as a first-type clearing node, and node authority of the first-type clearing node may be determined as first-type clearing authority.

The node identity herein may include two identity types. One identity type is a non-cross-chain type, and the other identity type is a cross-chain type. In some embodiments, a service node of the non-cross-chain type deployed in a public network and originating from the first service network may be referred to as a first-type clearing node (for example, the service node 110n in the embodiment corresponding to FIG. 4), and an identity of the non-cross-chain type of the first-type clearing node may be collectively referred to as a first identity type. In addition, in some embodiments, a service node of the cross-chain type deployed in a public network and originating from the second service network may be referred to as a second-type clearing node (for example, the service node 120a in the embodiment corresponding to FIG. 4), and an identity of the cross-chain type of the second-type clearing node may be collectively referred to as a second identity type. Likewise, in some embodiments, a service node of the cross-chain type deployed in a public network and originating from the third service network may be referred to as a third-type clearing node (for example, the service node 130g in the embodiment corresponding to FIG. 4), and an identity of the cross-chain type of the third-type clearing node may also be collectively referred to as the foregoing second identity type.

The node authority herein may include two types of node authority. One type of node authority is clearing authority of a non-cross-chain type, and the other type of node authority is clearing authority of a cross-chain type. In some embodiments, the clearing authority of the non-cross-chain type may be referred to as first-type clearing authority, and the clearing authority of the cross-chain type may be referred to as second-type clearing authority. An authority type of the foregoing first-type clearing node (for example, the service node 110n in the foregoing embodiment corresponding to FIG. 4) is first-type clearing authority. An authority type of the second-type clearing node (for example, the service node 120a in the embodiment corresponding to FIG. 4) is second-type clearing authority. An authority type of the third-type clearing node (for example, the service node 130g in the embodiment corresponding to FIG. 4) is also second-type clearing authority.

Operation 103: Invoke, when the identity authority verification result indicates that the service clearing node is a first-type clearing node corresponding to the first service object, and node authority of the first-type clearing node is first-type clearing authority, a first authority clearing contract associated with the first authority contract to obtain first service data associated with the first-type clearing node and first ledger data corresponding to the first service data from the first main chain, and obtain first contract data corresponding to the first ledger data from a contract database corresponding to the first main chain.

For example, the first-type clearing node is a service node in the first service network. The first-type clearing authority represents authority of the first-type clearing node originating from the first service network to obtain the first service data visible to the first service object from the first main chain.

In some embodiments, a block to which the first service data belongs is a first target block on the first main chain. A first chaining transaction to which the first service data belongs includes a node identifier of the first-type clearing node. The node identifier of the first-type clearing node is the target node identifier. The target node identifier written into the first chaining transaction may represent that the first chaining transaction in the first target block is visible to the first service object corresponding to the first-type clearing node. The first consensus node may invoke a data clearing method in the first authority contract, access the first authority clearing contract, write the target node identifier into the first authority clearing contract, invoke the first authority clearing contract to obtain the first target block associated with the first-type clearing node from the first main chain, obtain the first chaining transaction visible to the first-type clearing node from the first target block, and obtain the first service data corresponding to the target node identifier from the first chaining transaction. The first consensus node may obtain, from a ledger database corresponding to the first main chain, ledger data associated with the first service data as the first ledger data. The first consensus node may obtain, from a contract database corresponding to the first main chain, contract data associated with the first service data as the first contract data corresponding to the first ledger data.

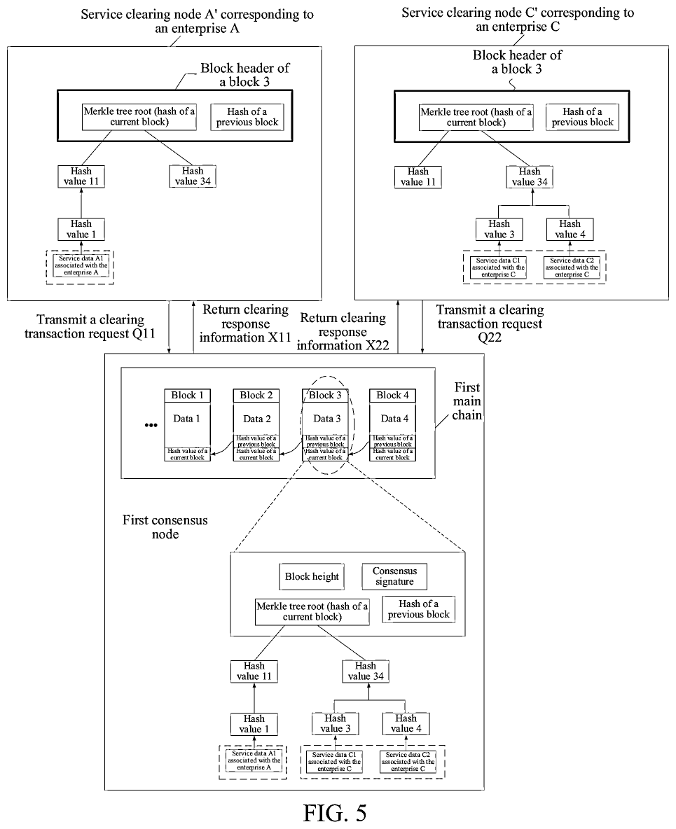

Referring to FIG. 5, FIG. 5 is a schematic diagram of data exchanging during data clearing according to some embodiments. A blockchain maintained by a first consensus node shown in FIG. 5 may be a first main chain shown in FIG. 5. The first main chain includes a series of blocks that are consecutive in a chronological order of generation. Once a new block is added to the blockchain, the new block is no longer removed. A11 blocks in the first main chain record transaction data (the transaction data herein includes service data A1, service data C1, and service data C2 obtained by the first consensus node executing a corresponding first service) determined by the first consensus node in the blockchain system to be chained. For example, the first main chain shown in FIG. 5 may include a block 1, a block 2, a block 3, and a block 4 that are consecutive to each other in a chronological order of generation.

A service clearing node A′ corresponding to an enterprise A and a service clearing node C′ corresponding to an enterprise C shown in FIG. 5 may be service nodes originating from the service network A21 in the embodiment corresponding to FIG. 4. After performing identity authority verification on the service clearing nodes (where the service clearing nodes herein are the service clearing node A′ and the service clearing node C′ shown in FIG. 5) through a node authority contract (for example, a first authority contract on the first main chain), the first consensus node may determine that the service clearing node A′ and the service clearing node C″ are first-type clearing nodes originating from the first service network, and then may invoke an authority clearing contract (which is a first authority clearing contract on the first main chain) corresponding to the node authority contract to obtain a first target block associated with these first-type clearing nodes from the first main chain shown in FIG. 5.

The first target block herein may be the block 3 shown in FIG. 5. In this case, the first consensus node may obtain a chaining transaction 1 visible to the service clearing node A′ from the first target block, and then may obtain service data (for example, service data A1 associated with the enterprise A shown in FIG. 5) in the chaining transaction 1. In addition, the first consensus node may obtain a chaining transaction 2 and a chaining transaction 3 that are visible to the service clearing node C′ from the first target block, and then may obtain service data C in the chaining transaction 3 while obtaining service data C2 (for example, service data C1 associated with the enterprise C shown in FIG. 5) in the chaining transaction 2.

In some embodiments, the enterprise A and the enterprise C may be used together as first service objects initiating clearing transaction requests. In this case, the chaining transaction 1, the chaining transaction 2, and the chaining transaction 3 herein are all chaining transactions obtained by the first consensus node from the block 3 for the first service objects. For case of distinction, in some embodiments, the chaining transaction 1 cleared by the first consensus node for the enterprise A may be used as a first chaining transaction, and the chaining transaction 2 and the chaining transaction 3 cleared by the first consensus node for the enterprise C may be used as second chaining transactions. For example, the second chaining transactions herein are invisible to the enterprise A serving as a first-type clearing node. Likewise, the first chaining transaction herein is also invisible to the enterprise C serving as a first-type clearing node.

For a block structure of the first main chain shown in FIG. 5, each block includes a hash value of a current block (for example, a hash of the current block shown in FIG. 5) recorded based on transaction data stored in the current block and a hash value of a previous block (for example, a hash of the previous block shown in FIG. 5). The blocks may be connected based on associations between the hash values indicated by arrows in FIG. 5 to form the first main chain shown in FIG. 5.

In addition, each block shown in FIG. 5 may further include information such as a block height of a corresponding block during generation and node signature information of consensus nodes in the first network during participation in consensus signature addition. In a block header of the block 3 shown in FIG. 5, the hash of the current block is a Merkle tree root of the current block (for example, a target root hash 1134 determined from a hash value 11 and a hash value 34 shown in FIG. 5). For the first consensus node shown in FIG. 5, the authority clearing contract corresponding to the node authority contract (for example, the first authority clearing contract on the first main chain) may be invoked to clear first ledger data corresponding to the first service data from the first main chain.

In some embodiments, the first target block includes a second chaining transaction other than the first chaining transaction. The second chaining transaction is a transaction invisible to the first service object corresponding to the first-type clearing node in the first target block.

The block 3 (for example, the first target block) shown in FIG. 5 may further include second chaining transactions (for example, the chaining transaction 2 to which service data C1 associated with the enterprise C belongs and the chaining transaction 3 to which service data C2 associated with the enterprise C belongs shown in FIG. 5) in addition to the first chaining transaction. To ensure security of the on-chain data on the first main chain, the second chaining transactions (for example, the chaining transaction 2 to which service data C1 associated with the enterprise C belongs and the chaining transaction 3 to which service data C2 associated with the enterprise C belongs shown in FIG. 5) are transactions that are invisible to the enterprise A corresponding to the service clearing node A′ in the block 3 (for example, the first target block).

In some embodiments, when the first target block is written to the first main chain, a block header of the first target block, data content of the first service data belonging to the first chaining transaction, an associated state root associated with the second chaining transaction, and a Merkle verification path configured to assist in performing verification on the first service data are used as the first ledger data corresponding to the first target block, and the first ledger data is added to the ledger database corresponding to the first main chain. A contract name, a contract method, and a contract address of the first service contract invoked for executing the first service are used as the first contract data corresponding to the first ledger data, and the first contract data is added to the contract database corresponding to the first main chain.

For example, for the service clearing node A′ corresponding to the enterprise A, the first ledger data corresponding to the first service data cleared by the first consensus node from the first main chain may include a block header of the first target block (for example, a block header of the block 3 shown in FIG. 5, where the block header herein may be configured for performing integrity verification on the obtained first service data), data content of the first service data (for example, data content of the service data A1 associated with the enterprise A shown in FIG. 5) belonging to the first chaining transaction, an associated state root (for example, a hash value 34 shown in FIG. 5, a hash value 1 shown in FIG. 5, and a hash value 11 corresponding to the hash value 1) associated with the second chaining transaction, and a Merkle verification path configured to assist in performing verification on the first service data (for example, a method for reconstructing branches of a bifurcate tree of a Merkle tree root based on the hash value 34 shown in FIG. 5, the hash value 1 corresponding to the service data A1 shown in FIG. 5, and the hash value 11 corresponding to the hash value 1). In some embodiments, the reconstructed Merkle tree root may be compared with a Merkle tree root in the block header of the foregoing block 3. In a case that the two are consistent, the integrity of the first service data cleared from the first main chain may be determined.

An example in which the enterprise A is a bill issuance enterprise (for example, a bill issuance service provider) is used herein. In a case that the enterprise A accesses the first network through the foregoing service clearing node A′, the enterprise A may clear, through the first consensus node in the first network, an electronic bill in a bill issuance transaction related to the enterprise A from the first main chain. The service data A1, shown in FIG. 5, associated with the enterprise A may be the electronic bill, cleared by the first consensus node from the first main chain, in the bill issuance transaction related to the enterprise A. The bill issuance transaction herein is the foregoing first chaining transaction. The electronic bill in the bill issuance transaction may be an electronic bill (for example, an electronic bill P1) whose issuance through the first service contract (for example, an electronic bill issuance contract) on the first consensus node is requested by the enterprise A for a consumer (for example, the enterprise B). The first contract data corresponding to the first ledger data obtained by the first consensus node from the contract database corresponding to the first main chain may include a contract name, a contract method, and a contract address of the first service contract (for example, the electronic bill issuance contract) invoked for executing the bill issuance transaction (for example, the foregoing first service).

In addition, an example in which the enterprise C is a local taxation bureau is used herein. The enterprise C serving as the local taxation bureau may obtain, through an electronic bill circulation contract in the first consensus node, electronic bills (for example, the electronic bill P2) reimbursed by some reimbursement enterprises (for example, the foregoing enterprise B), and may then circulate, through the electronic bill circulation contract in the first consensus node, an electronic bill (for example, an electronic bill P3) obtained by the enterprise C to a state taxation administration D, and the state taxation administration D may archive the circulated electronic bill through the electronic bill archiving contract in the first consensus node. Based on this, for the service clearing node C′ corresponding to the enterprise C, the service data C1 associated with the enterprise C may be the electronic bill P2 obtained by the enterprise C and reimbursed by the enterprise B. Similarly, the service data C2 associated with the enterprise C may be the electronic bill P3 to be circulated by the enterprise C to the state taxation administration D.

Based on this, for the service clearing node C′ corresponding to the enterprise C, the first ledger data corresponding to the first service data cleared by the first consensus node from the first main chain may include a block header of the first target block (for example, a block header of the block 3 shown in FIG. 5), data content of the first service data (for example, bill content of the foregoing electronic bill P2 and bill content of the foregoing electronic bill P3) belonging to the second chaining transaction, an associated state root (for example, a hash value 11 shown in FIG. 5, a hash value 3 and a hash value 4 shown in FIG. 5, and a hash value 34 calculated based on the hash value 3 and the hash value 4) associated with the second chaining transaction, and a Merkle verification path configured to assist in performing verification on the first service data (for example, a method for reconstructing branches of a bifurcate tree of a Merkle tree root based on the hash value 11 shown in FIG. 5, the hash value 3 and the hash value 4 shown in FIG. 5, and the hash value 34 calculated based on the hash value 3 and the hash value 4). In addition, the first contract data corresponding to the first ledger data obtained by the first consensus node from the contract database corresponding to the first main chain may include a contract name, a contract method, and a contract address of the first service contract (for example, the electronic bill circulation contract) invoked for circulating the electronic bill P2 and the electronic bill P3.

The chain entrance corresponding to the first network herein is the first chain entrance, and the multi-blockchain herein further includes the target main chain independent of the first main chain. The first service data herein is a service execution result obtained after the first consensus node executes the first service. The first consensus node further writes a block (for example, the first target block) to which the first chaining transaction including the service execution result belongs into the first main chain before clearing the first service data from the first main chain.

In some embodiments, a process in which the first consensus node executes the first service and writes the block to which the first chaining transaction belongs into the first main chain may be described as follows: The first consensus node may obtain a first transaction chaining request through the first chain entrance, and obtain, from the first transaction chaining request, a first service requested by the first service object and a first to-be-chained transaction corresponding to the first service, the first transaction chaining request being transmitted by the first service object through the first-type clearing node. The first consensus node writes the first to-be-chained transaction into the first authority contract, invokes a second authority verification method in the first authority contract, accesses a first cross-chain reading contract on the first main chain, and reads service processing authority verification information associated with the first service across chains from the target main chain based on the first cross-chain reading contract. The first consensus node may write the first service into a first service contract on the first main chain when determining, based on the service processing authority verification information, that the service object has service processing authority to process the first service. The first consensus node may invoke a first service execution method in the first service contract to execute the first service, to obtain a first service execution result corresponding to the first service, and use the first service execution result as the first service data associated with the first-type clearing node. The first consensus node may generate the first chaining transaction corresponding to the first to-be-chained transaction based on the first service data and the target node identifier, and write the first target block including the first chaining transaction into the first main chain.

In some embodiments, when the first service includes an electronic bill issuance service, and the first service contract includes an electronic bill issuance contract, the operation in which the first consensus node invokes a first service execution method in the first service contract to execute the first service, to obtain a first service execution result corresponding to the first service, and uses the first service execution result as the first service data associated with the first-type clearing node may be described as follows: The first consensus node may invoke a subcontract accessing method in the first service contract to access the electronic bill issuance contract, and execute the electronic bill issuance service in the first service based on the first service execution method in the electronic bill issuance contract, to obtain a target electronic bill issued for the service object. The target electronic bill is the first service execution result corresponding to the first service. The first consensus node may use the first service execution result as the first service data associated with the first-type clearing node.

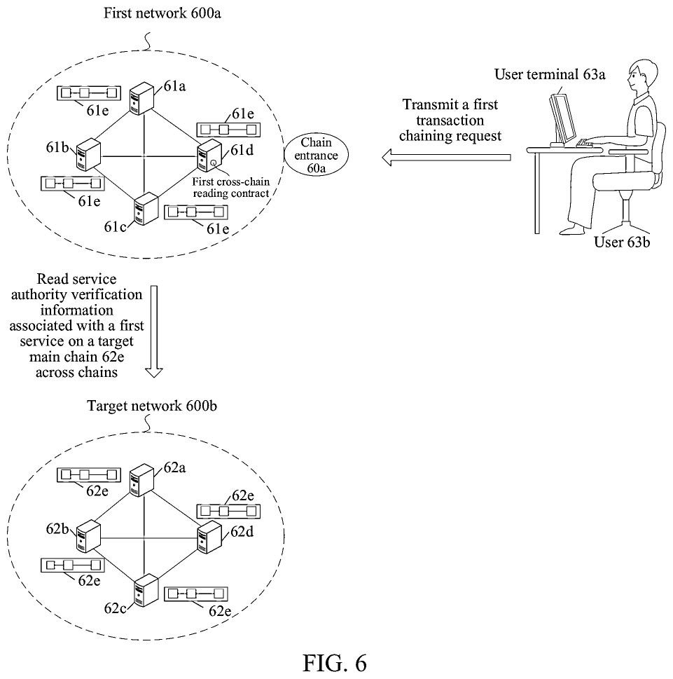

Referring to FIG. 6, FIG. 6 is a schematic diagram of a scenario of obtaining service authority verification information associated with a first service according to some embodiments. A user 63b shown in FIG. 6 may be the foregoing first service object. For example, in this case, the user 63b is the foregoing public network participant requesting to access a first network 600a. In some embodiments, a user terminal 63a used by the user 63b may be a first-type clearing node corresponding to the first service object. The first-type clearing node herein may be a service node in the service network A21 shown in FIG. 1. In this case, the first-type clearing node herein may execute a chaining transaction (for example, a bill issuance transaction) through the first consensus node. When obtaining transaction data corresponding to the chaining transaction, the first-type clearing node may add the transaction data together with signature information of the user 63a (for example, the service object) to a first transaction chaining request shown in FIG. 6, to transmit the first transaction chaining request to a chain entrance 60a corresponding to the first network 600a shown in FIG. 6.

The chain entrance 60a herein is the foregoing first chain entrance. As shown in FIG. 6, the first chain entrance may be configured to store registration data information of an authorized object shown in FIG. 6. The registration data information of the authorized object may include a public key certificate of the authorized object.

The registration data information of the authorized objects stored in the chain entrance 60a is obtained by a consensus node in the first network 600a from a target main chain 62c shown in FIG. 6. Since the foregoing TBFT consensus algorithm is run on the consensus node in the first network, in the TBFT consensus algorithm, on the premise that a leader node is rotated, assuming that a leader node configured to consecutively produce blocks in a previous round is a consensus node 61c shown in FIG. 6, and a leader node configured to consecutively produce blocks in the current round is a consensus node 61d shown in FIG. 6, the consensus node 61c may be used as a first consensus node in the previous round, and the consensus node 61d may be used as a new first consensus node in the current round. Based on this, the registration data information of the authorized objects stored in the chain entrance 60a may include registration data information (for example, a public key certificate A1 of an authorized object A and a public key certificate BI of an authorized object B) of a first-type authorized object obtained by a consensus node 61c historically serving as the first consensus node from a target main chain (for example, the target main chain 62e shown in FIG. 6) based on a first cross-chain reading contract shown in FIG. 6, and may further include registration data information (for example, a public key certificate NI of an authorized object N) of a second-type authorized object obtained by a consensus node 61d currently serving as a first consensus node from the target main chain (for example, the target main chain 62e shown in FIG. 6) based on the first cross-chain reading contract shown in FIG. 6. The registration data information of the first-type authorized object and the registration data information of the second-type authorized object herein are configured for distinguishing which are synchronized by the consensus node 61c and the consensus node 61d as first consensus nodes and which are synchronized by other nodes as first consensus nodes.

An example in which the consensus node 61d is used as the first consensus node is used herein to describe a process of performing identity authentication on the user 63b through the chain entrance 60a of FIG. 6. For example, in a scenario in which the blockchain system is applied to a blockchain electronic bill, when the first service is the foregoing bill service, a real-time service flow herein may be a real-time electronic bill flow. For example, the real-time electronic bill flow may refer to a bill service flow formed by a large number of bill services in a state of being frequently requested determined by the first consensus node through the foregoing first chain entrance (for example, the chain entrance 60a).

The first chain entrance (for example, the chain entrance 60a) in some embodiments further stores a chain access count threshold obtained from the target main chain (the chain access count threshold herein represents access traffic of the first chain entrance, and the chain access count threshold herein includes, but is not limited to, a maximum concurrent request access count). A maximum concurrent request access count of a first transaction chaining request obtained by the chain entrance 60a is determined by the foregoing internal management contract run on the management consensus node in a target network 600b. In some embodiments, the internal management contract run on the target consensus node (for example, the consensus node 62a shown in FIG. 6) may be configured to manage maximum concurrent request access counts obtained at chain entrances in the three-chain system. By controlling concurrent access traffic (for example, the foregoing maximum concurrent request access counts) at the chain entrances, stable execution of the first service flow in the first network 600a may be ensured, thereby ensuring that the first consensus node has sufficient storage resources to store a service data flow formed by a large amount of service data.

In some embodiments, signature information of the user 63a (for example, the first service object) may be collectively referred to as object signature information, and the object signature information is obtained after the user 63a (for example, the first service object) adds a signature to transaction data based on private key information (for example, first private key information of the first service object) of the user 63a. When the chain entrance 60a shown in FIG. 6 obtains the first transaction chaining request, a request cumulative count (for example, the foregoing incremented request access count) corresponding to the first transaction chaining request may be counted. Further, when the request cumulative count corresponding to the first transaction chaining request does not reach the chain access count threshold (for example, the foregoing maximum concurrent request access count), access authority verification (also referred to as access authority verification) may be preliminarily completed on the user 63b may. In this case, the first consensus node may further obtain object signature information of the service object from the first transaction chaining request. Further, public key certificates of authorized objects (for example, the public key certificate A1 of the authorized object A, the public key certificate BI of the authorized object B, . . . , and the public key certificate NI of the authorized object N) may be quickly obtained from the registration data information of the authorized objects stored in the chain entrance 60a, to perform identity verification on the user 63b based on the obtained public key certificates. In some embodiments, when the request cumulative count corresponding to the first transaction chaining request reaches the chain access count threshold (for example, the maximum concurrent request access count), the first transaction chaining request transmitted by the user 63b may be directly rejected, and a notification message configured to prompt the user 63b to wait for access may be generated.

The public key certificates of the authorized objects herein all include public key information of a corresponding authorized object. The first consensus node may further search the public key certificates of the authorized objects to check whether a public key certificate of the user 63b exists. (1) If the public key certificate of the user 63b exists, the first consensus node may use the public key certificate of the user 63b as a found first public key certificate of the first service object, and may use public key information of the user 63b recorded in the first public key certificate as first public key information, to perform signature verification on the object signature information based on the first public key certificate and the first public key information, thereby obtaining a signature verification result of the service object. (2) If the public key certificate of the user 63b does not exist, the first consensus node does not search the public key certificates of the authorized objects to check whether the public key certificate of the user 63b exists, the first consensus node confirms that the user 63b (for example, the service object) is an invalid service object and may reject the first transaction chaining request transmitted by the user 63b serving as the invalid service object.

In some embodiments, signature verification may be further performed on the object signature information with reference to certificate data information (for example, version information of the certificate, a hash value of the certificate, and a root certificate hash value associated with the hash value of the certificate) of a public key certificate stored in the chain entrance 60a, to ensure reliability of public key information (for example, the foregoing first public key information) in the public key certificate (for example, the foregoing first public key certificate) used for signature verification.

The first consensus node may use certificate data information of the first public key certificate as to-be-processed certificate information, and may invoke a certificate data reading method in the first cross-chain reading contract to read a public key certificate of the service object from the target main chain. The first consensus node may use the read certificate data information in the public key certificate of the service object as target certificate information, and then may perform signature verification on object signature information based on the first public key information when the to-be-processed certificate information is consistent with the target certificate information, and use a verification result obtained when the signature verification succeeds as a signature verification result of the service object.

When the to-be-processed certificate information is inconsistent with the target certificate information, the first public key certificate may be updated with the public key certificate of the user 63b read from the target main chain, and signature verification may be performed on the object signature information based on public key information in the updated first public key certificate, to ensure successful execution of the first service requested by the user 63b in the first network.

The public key certificate of the authorized object involved in some embodiments is obtained by invoking, by the target consensus node in the target network, an object identity management contract (for example, the object identity management contract in the embodiment corresponding to FIG. 2) in the target main chain to perform identity registration on object data information (for example, the object data information herein may include user data information of the foregoing user 63b, a transaction service to be executed by the foregoing user 63b, and a service type of the transaction service) submitted by the service object requesting to register a corresponding transaction service (for example, the foregoing first service). In a case that the target consensus node successfully configures a public key certificate corresponding to a corresponding service for the service object requesting to register the corresponding transaction service (for example, the foregoing first service), the service object requesting to register the corresponding transaction service (for example, the foregoing first service) may serve as an authorized object, and the public key certificate configured for the authorized object may be written into the target main chain (for example, a target main chain 61e shown in FIG. 6), and when the service object subsequently requests to execute the first service in the first network, the first consensus node may further update the public key certificate of the service object in the chain entrance (for example, the foregoing first chain entrance) by using the public key certificate on the target main chain read across chains. In view of the above, in some embodiments, the registration data information of the authorized object obtained from the target main chain can be updated based on a cross-chain reading timestamp.

In addition, after writing the public key certificate configured for the authorized object (for example, the user 63b shown in FIG. 6) into the target main chain (for example, the target main chain 61e shown in FIG. 6), the target consensus node may further return private key information (for example, the first private key information) synchronously configured for the authorized object (for example, the user 63b shown in FIG. 6) to the user 63b, and when the user 63b serves as the service object, the user 63b may add, based on the first private key information, a signature to transaction data submitted by user 63b, to obtain the object signature information. In view of the above, the first private key information of the service object herein is obtained after the service object (for example, the user 63b shown in FIG. 6) performs identity registration based on the object identity management contract in the target main chain. Based on this, the object signature information herein is obtained after a first service node associated with the service object (for example, the user 63b shown in FIG. 6) adds a signature to the foregoing transaction data based on the first private key information of the service object (for example, the user 63b shown in FIG. 6).

As shown in FIG. 6, the first consensus node may perform identity verification on the user 63b based on the registration data information of the authorized object obtained from the chain entrance 60a and may determine, when the identity verification succeeds, that the user 63b is an authorized object, to allow the user 63b to access the first network 600a as an accessing party. In this case, the first consensus node may perform transaction assembly on the foregoing transaction data in the first network, to obtain a first service associated with the service object, and may perform transaction broadcasting in the first network by using the first service as a new transaction, to perform a transaction duplication check on the new transaction in the first network. In a case that the transaction duplication check succeeds (for example, it is determined that there is no first service the same as the new transaction in the first network), the new transaction may be added to a transaction pool corresponding to the foregoing real-time first service flow. Based on first services in the real-time first service flows in the transaction pool, the first cross-chain reading contract shown in FIG. 6 is invoked to read first service processing authority verification information associated with the first services across chains from the target main chain 62e, and it can be determined, based on the first service processing authority read across chains, whether the user 63b (the first service object) has service processing authority to process the first service.

For the first transaction chaining request initiated by the user 63b, registration data information of the authorized object obtained from the target main chain and stored in the chain entrance 60a may be different from authorized access data information of the authorized object obtained from the target main chain for the foregoing clearing transaction request and stored in the chain entrance 60a.

When determining, based on the service authority verification information, that the first service object has the service processing authority to process the first service, the first consensus node (the consensus node 61d) may write the first service to a first service contract on the first main chain, and then may invoke a first service execution method in the first service contract to execute the first service, to obtain a first service execution result corresponding to the first service (for example, when the first service is an electronic bill issuance service, and the first service contract is an electronic bill issuance contract, the first service execution result herein may include an electronic bill obtained by executing the electronic bill issuance service). In some embodiments, the first service execution result may be used as first service data associated with the first-type clearing node (for example, the first service data herein may be the electronic bill P1 associated with the foregoing enterprise A in the foregoing embodiment corresponding to FIG. 5). The first consensus node (the consensus node 61d) may write a node identifier (for example, the target node identifier) of the user terminal 63a into the first to-be-chained transaction when the first service data is encapsulated into the first to-be-chained transaction and may use the first to-be-chained transaction into which the target node identifier is written as the foregoing first chaining transaction, and the first consensus node may subsequently write a first target block (for example, the block 3 in the embodiment corresponding to FIG. 5) including the first chaining transaction into the first main chain.

Operation 104: Use the first service data, the first ledger data, and the first contract data as first clearing response information corresponding to the clearing transaction request, and return the first clearing response information to the first-type clearing node having the first-type clearing authority, to cause the first-type clearing node to recover a sub-ledger corresponding to the first ledger data based on the first clearing response information.

In some embodiments, that the ledger data associated with the first service data is obtained from the ledger database corresponding to the first main chain as the first ledger data may be implemented through the following technical solution: searching the ledger database corresponding to the first main chain for the block header of the first target block, the data content of the first service data belonging to the first chaining transaction, the associated state root associated with the second chaining transaction, and the Merkle verification path configured to assist in performing verification on the first service data; using the block header of the first target block, the data content of the first service data, the associated state root, and the Merkle verification path that are found as the ledger data associated with the first service data obtained from the ledger database corresponding to the first main chain; and using the ledger data associated with the first service data as the first ledger data.

In some embodiments, that the contract data associated with the first service data is obtained from the contract database corresponding to the first main chain as the first contract data corresponding to the first ledger data may be implemented through the following technical solution: searching the contract database corresponding to the first main chain for the contract name, the contract method, and the contract address of the first service contract invoked for executing the first service; using the contract name of the first service contract, the contract method of the first service contract, and the contract address of the first service contract that are found as the contract data associated with the first service data obtained from the contract database corresponding to the first main chain; and using the contract data associated with the first service data as the first contract data corresponding to the first ledger data.

When the first service data is an electronic bill, the first consensus node may use first ledger data (for example, a block header of the block 3, bill content of the electronic bill P1, a state root associated with another chaining transaction belonging to a same block as the electronic bill P1, and a Merkle tree root that are found from a ledger database) associated with the electronic bill (for example, the electronic bill P1 in the embodiment corresponding to FIG. 5) and first contract data (for example, a contract name, a contract method, a contract address, and the like of an electronic bill issuance contract invoked for executing the electronic bill issuance service and found from a contract database) associated with the electronic bill as first clearing response information, and return the first clearing response information to a first-type clearing node (for example, the service node 110n deployed in the service network A21) with first-type clearing authority, to cause the first-type clearing node (for example, the service node 110n deployed in the service network A21) to recover a sub-ledger corresponding to the first ledger data based on the first clearing response information. For details of the sub-ledger herein, reference may be made to a sub-ledger associated with the block header of the block 3 and constructed in the service clearing node A′ corresponding to the enterprise A in the embodiment corresponding to FIG. 5.

Some embodiments provide a novel node identity authority verification mechanism. The node identity authority verification mechanism is intended to emphasize that different node identities may be configured for service nodes in service networks associated with different chains in a multi-blockchain network architecture. In some embodiments, when data clearing may be performed on the service nodes in the service networks associated with different chains, the service nodes originating from different service networks may be collectively referred to as service clearing nodes. Corresponding node identities may be pre-configured for the service nodes used as service clearing nodes. For example, in a case that a service network associated with a first main chain is the first service network, when a service node originating from the first service network may be used as a service clearing node, a node identity pre-configured for the service clearing node is a first-type clearing node. In addition, in some embodiments, a node identity of a service clearing node transmitting a first transaction clearing request may be intelligently identified through the target node identifier written into the first authority contract on the first main chain, and the node authority of the first-type clearing node can be quickly determined based on the node identity (for example, the foregoing first-type clearing node) intelligently identified, and service data matching the node authority of the first-type clearing node may be obtained from the first main chain as the first service data. The phenomenon that other service data on the first main chain is obtained by the first-type clearing node can be resolved from the root. Further, data security during data clearing can be improved based on an identity authority verification mechanism. In addition, since the first service data on the first main chain is only visible to a service object corresponding to the first-type clearing node, it may be difficult for a service clearing node of another node identity to directly obtain the first service data from the first main chain. Some embodiments can further ensure privacy and security isolation of the on-chain data on the first main chain from the root.

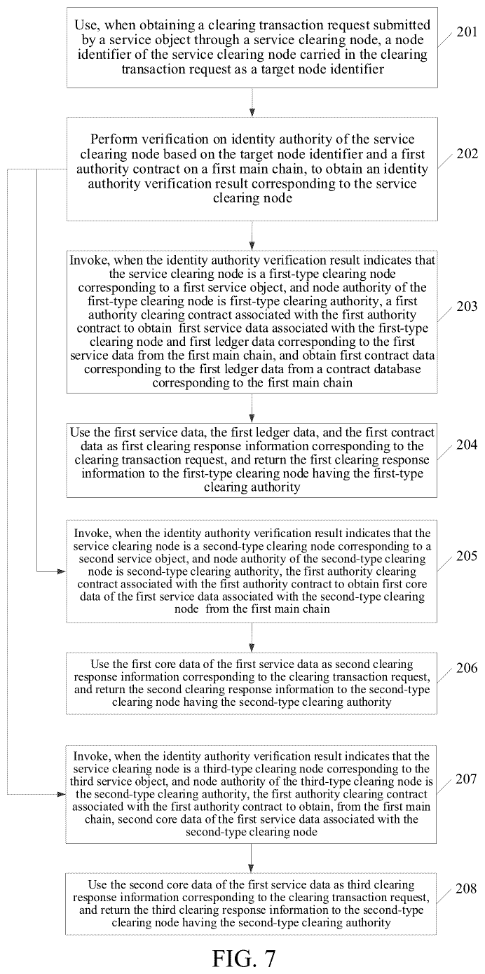

Referring to FIG. 7, FIG. 7 is a schematic diagram of a data processing method based on a multi-blockchain according to some embodiments. As shown in FIG. 7, the method may be performed by a first consensus node in the foregoing first network. For example, the first consensus node may be any consensus node in the consensus network A22 shown in FIG. 1. The method may include the following operation 201 to operation 208.

Operation 201: Use, when obtaining a clearing transaction request submitted by a service object through a service clearing node, a node identifier of the service clearing node carried in the clearing transaction request as a target node identifier.

The service object includes a first service object associated with a first service network. The first service network is a service network associated with the first network.

Operation 202: Perform verification on identity authority of the service clearing node based on the target node identifier and a first authority contract on the first main chain, to obtain an identity authority verification result corresponding to the service clearing node.

Operation 203: Invoke, when the identity authority verification result indicates that the service clearing node is a first-type clearing node corresponding to the first service object, and node authority of the first-type clearing node is first-type clearing authority, a first authority clearing contract associated with the first authority contract to obtain first service data associated with the first-type clearing node and first ledger data corresponding to the first service data from the first main chain, and obtain first contract data corresponding to the first ledger data from a contract database corresponding to the first main chain.

The first-type clearing node is a service node in the first service network. The first-type clearing authority represents that the first-type clearing node originating from the first service network has data obtaining authority, the data obtaining authority being authority to obtain the first service data visible to the first service object from the first main chain.

Operation 204: Use the first service data, the first ledger data, and the first contract data as first clearing response information corresponding to the clearing transaction request, and return the first clearing response information to the first-type clearing node having the first-type clearing authority, to cause the first-type clearing node to recover a sub-ledger corresponding to the first ledger data based on the first clearing response information.

For implementation details of operation 201 to operation 204, reference may be made to the descriptions of operation 101 to operation 104 and FIG. 3.

After performing the foregoing operation 202, the first consensus node may further perform the following operation 205 to operation 206 based on the identified node identity of the service clearing node.

In some embodiments, the multi-blockchain further includes a second main chain independent of the first main chain, and a chain entrance of the second main chain is a second chain entrance. A second network corresponding to the second main chain is a consensus network independent of the first network. A service network associated with the second network is a second service network. The service object includes a second service object.

Operation 205: Invoke, when the identity authority verification result indicates that the service clearing node is a second-type clearing node corresponding to the second service object, and node authority of the second-type clearing node is second-type clearing authority, the first authority clearing contract associated with the first authority contract to obtain first core data of the first service data associated with the second-type clearing node from the first main chain.

The second-type clearing node is a service node in the second service network. The first core data is partial data visible to the second service object corresponding to the second-type clearing node in the first service data. The second-type clearing authority represents that the second-type clearing node originating from the second service network has local data obtaining authority, the local data obtaining authority being authority to obtain local data in the first service data from the first main chain and authority of the second-type clearing node to obtain second service data different from the first service data from the second main chain.

Operation 206: Use the first core data of the first service data as second clearing response information corresponding to the clearing transaction request, and return the second clearing response information to the second-type clearing node having the second-type clearing authority.

When the second-type clearing node generates, based on the second clearing response information, a second transaction chaining request associated with a second service, the second-type clearing node may transmit the second transaction chaining request to a second consensus node in the second network corresponding to the second main chain through the second chain entrance. The second network is a consensus network independent of the first network. The second consensus node invokes, when determining, based on the second transaction chaining request, that the second service object has service processing authority to process the second service, a second service contract on the second main chain to execute the second service, to use a second service execution result obtained by executing the second service as the second service data.

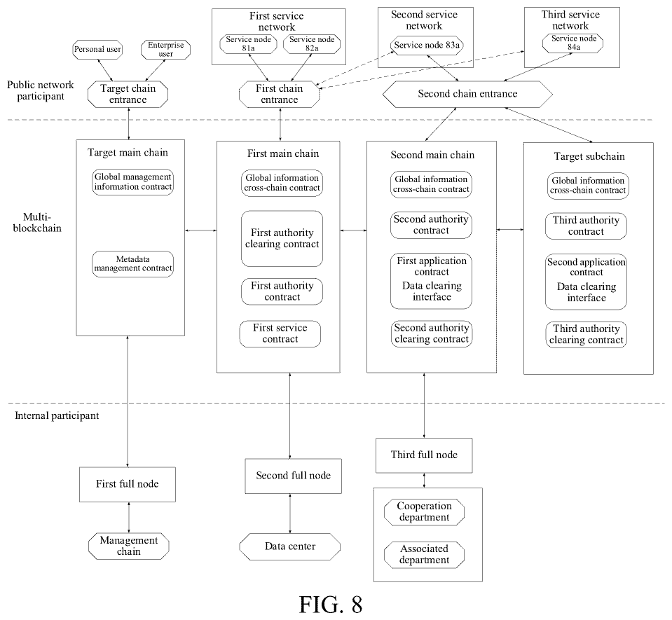

Referring to FIG. 8, FIG. 8 is a schematic diagram of data exchanging of a blockchain system based on a multi-blockchain according to some embodiments. A first service network shown in FIG. 8 is a service network having an association with a first main chain. A service node 81a and a service node 82a shown in FIG. 8 may perform the foregoing data chaining interaction and the foregoing data clearing interaction with the first main chain through a first chain entrance shown in FIG. 8.

As shown in FIG. 8, a chain entrance corresponding to a target main chain is a target chain entrance, and a management department (for example, the foregoing taxation management department) may implement global configuration, through a global management information contract, on global configuration information of blockchains in the blockchain system on the target main chain through the target chain entrance. For implementation details of how the management department performs global configuration, through the global management information contract, on the global configuration information of the blockchains, reference may be made to the descriptions of the global management information contract deployed on the management chain and FIG. 2. For implementation details of how the management department obtains all ledger data (for example, the full ledger data) from the target main chain through a first full node, reference may be made to the descriptions of the full node of the management chain and FIG. 2.

When a service node 81a and a service node 82a perform data clearing interaction with the first main chain through the first chain entrance shown in FIG. 8, the first chain entrance may receive a clearing transaction request initiated by the service node 81a in the first service network, or may receive another clearing transaction request initiated by the service node 82a in the first service network. On the foregoing blockchain electronic bill issuance service platform, a service node deployed in the first service network may be a simple payment verification (SPV) node. For example, the service node 81a herein may be an SPV node corresponding to a local taxation bureau (for example, a local taxation bureau SPV1), and the service node 82a may be an SPV node corresponding to another local taxation bureau (for example, a local taxation bureau SPV2).

A first service object corresponding to a service node (for example, an SPV node) deployed in the first service network may be a taxation authority deployed externally such as a local taxation bureau, customs, or a large-scale enterprise (for example, some independent enterprises). When such SPV nodes access, through the first chain entrance shown in FIG. 8, the first network on which the first main chain is located, preliminary access authentication may be performed on the SPV nodes through the first chain entrance. When the SPV nodes access the first network, a first consensus node may invoke a first authority contract (for example, the electronic bill node authority contract deployed on the bill chain in the embodiment corresponding to FIG. 2, for example, an electronic invoice SPV authority contract) on the first main chain to perform identity authority verification (for example, perform identity verification and authority verification) on the SPV nodes that have identities registered through the target main chain.

For implementation details of performing preliminary access authentication on the SPV nodes through the first chain entrance, reference may be made to the descriptions of access authentication and FIG. 3.

In a case that the first authority contract has been deployed on the first main chain, the first service object (for example, a local taxation bureau or an independent enterprise) involved in some embodiments may further access the first authority contract directly through a service clearing node associated with the local taxation bureau, the independent enterprise, or the like, to register a node identity and node authority through the first authority contract. After the registration succeeds, the service clearing node associated with the local taxation bureau, the independent enterprise, or the like may be allowed to further access the first authority clearing contract (for example, the electronic invoice authority clearing contract deployed on the foregoing bill chain) on the first main chain. The first service object may obtain, on the first main chain, an electronic bill that the first service object has authority to read and a ledger data related to the read electronic bill.

A first authority clearing contract (for example, the electronic invoice authority clearing contract deployed on the bill chain) may be invoked to obtain ledger data (for example, the first ledger data), such as a block header, transaction detail content (for example, bill content of the electronic bill), a state root (for example, a state root associated with another electronic bill other than the electronic bill in the first target block), and a Merkle verification path, of the first target block to which the electronic bill belongs. In addition, contract data (for example, the first contract data) of the first service contract invoked for generating the electronic bill may also be obtained by invoking the first authority clearing contract (for example, the electronic invoice authority clearing contract deployed on the bill chain).

Service clearing nodes (for example, the service node 81a and the service node 82a in FIG. 8) associated with the local taxation bureau, the independent enterprise, and the like may perform sub-ledger recovery locally on the service node 81a and the service node 82a when obtaining clearing response information (for example, the foregoing first clearing response information) returned by the first consensus node on the first main chain.

Both the service node 81a and the service node 82a involved in some embodiments may perform verification on electronic bills visible to them locally, and both the service node 81a and the service node 82a may perform chaining operations, such as bill issuance, on the first main chain (for example, the bill chain) through the first chain entrance shown in FIG. 8. The service node 81a and the service node 82a deployed in the first service network may obtain partial ledger data (for example, the foregoing first ledger data) through an interface provided by a corresponding contract (for example, a data clearing interface provided by the first authority clearing contract on the first main chain), and the service node 81a and the service node 82a deployed in the first service network do not have authority to directly access original ledger data on the first main chain. In view of the above, a local invoice SPV node deployed in the first service network may be used by a local taxation bureau, a taxation participation authority, an enterprise, or the like. The local taxation bureau, the taxation participation authority, or the enterprise may use the local invoice SPV node deployed in the first service network to ensure that a public network participant can obtain a sub-ledger that the public network participant has authority to view.

A data center shown in FIG. 8 may be the foregoing electronic bill data center. A full SPV node (for example, a second full node shown in FIG. 8) associated with the ledger interface of the first main chain may be deployed in a taxation management department or a related invoice audit and supervision department, and all ledger data on the first main chain may be fully synchronized from the first main chain. The full SPV node (for example, the second full node shown in FIG. 8) may directly perform data synchronization through the ledger interface of the first main chain (for example, the foregoing bill chain) without interacting with a contract on the first main chain. The full SPV node (for example, the second full node shown in FIG. 8) involved in some embodiments is used by invoice management and supervision departments, and can interact with the foregoing bill chain. For example, the second full node has completely transparent data access authority to the first main chain.

In some embodiments, when the ledger interface corresponding to the first network is a first ledger interface, the first consensus node may obtain a block synchronization request through the first ledger interface, the block synchronization request being transmitted by a service synchronization object through a service synchronization node (for example, the second full node shown in FIG. 8) and may obtain, from the block synchronization request, a first block height submitted by the service synchronization object. The first block height is a block height of a first block in a local blockchain locally stored on the service synchronization node. The first block is a block with a maximum block height on the local blockchain. The first consensus node may use a block with a maximum block height on the first main chain as a second block, and use a block height of the second block as a second block height. When the second block height is greater than the first block height, the first consensus node may obtain a block between the first block height and the second block height from the first main chain as a to-be-synchronized block. The first consensus node may determine full ledger data and full contract data corresponding to the full ledger data based on the to-be-synchronized block, the full ledger data and the full contract data being configured to be transmitted to the service synchronization node. The first consensus node returns the full ledger data and the full contract data to the service synchronization node when returning the to-be-synchronized block the service synchronization node, to cause the service synchronization node to locally construct, when adding the to-be-synchronized block to the local blockchain, local full ledger data corresponding to the full ledger data and local full contract data corresponding to the full contract data synchronously.

As shown in FIG. 8, a service node 83a in a second service network may access the first network through the first chain entrance and may perform, through the first chain entrance, preliminary access authentication on an SPV node originating from the second service network. When the access authentication succeeds, the SPV nodes accesses the first network, and the first consensus node invokes the first authority contract (for example, the electronic bill node authority contract deployed on the bill chain in the embodiment corresponding to FIG. 2, for example, an electronic invoice SPV authority contract) on the first main chain to perform identity authority verification (for example, perform the identity verification and the authority verification) on the SPV node originating from the second service network.

For implementation details of performing, through the first chain entrance, preliminary access authentication on the SPV node originating from the second service network, reference may be made to the descriptions of access authentication and FIG. 3. The first consensus node may determine, based on the first authority contract on the first main chain, that the SPV node originating from the second service network is the foregoing second-type clearing node, and node authority of the second-type clearing node is the foregoing second-type clearing authority. In this case, the first consensus node may further invoke the first authority clearing contract on the first main chain to obtain first core data of first service data associated with the second-type clearing node from the first main chain, and then may return the first core data to the second-type clearing node through a data clearing interface of a first application contract deployed on a second main chain shown in FIG. 8. In this case, the service node 83a deployed in the second service network may obtain, from the first main chain, core data (for example, the foregoing first core data, where the first core data herein may be a name of a bill issuance enterprise in the electronic bill) in an electronic bill visible to a second service object corresponding to the service node 83a.

When obtaining the core data (for example, the foregoing first core data, where the first core data herein may be a name of a bill issuance enterprise in the electronic bill) in the electronic bill, the service node 83a deployed in the second service network may submit a second transaction chaining request to the second main chain shown in FIG. 8 based on the obtained core data in the electronic bill, to enable a second consensus node on the second main chain to invoke, after obtaining the second transaction chaining request through a second chain entrance, a second authority contract on the second main chain to determine service processing authority of the second service object initiating the second transaction chaining request. When it is determined that the second service object has the service processing authority to process a second service, the second service may be written into the first application contract on the second main chain. The second consensus node may further invoke a first service execution method in the first application contract to execute the second service, to obtain a second service execution result corresponding to the second service, and use the second service execution result as the second service data associated with the second-type clearing node. The second consensus node may further generate a second chaining transaction corresponding to a second to-be-chained transaction based on the second service data and a node identifier of the service node 83a, and write a second target block including the second chaining transaction into the second main chain. For implementation details of how the service node 83a deployed in the second service network clears, from the second main chain, the second service data associated with the service node 83a, second ledger data corresponding to the second service data, and second contract data corresponding to the second ledger data, reference may be made to the descriptions of how the service node in the first service network clears the first service data associated with the service node from the first main chain, the first ledger data corresponding to the first service data, and the first contract data corresponding to the first ledger data. The second service executed by the second consensus node on the second main chain may include various derivative services associated with the first service. Corresponding application contracts may be deployed on the second main chain for the different derivative services. The application contracts can pass through a unified data clearing interface, for the second authority clearing contract to access an application contract corresponding to a derivative service, to return the second service data, the second ledger data, and the second contract data cleared from the second main chain to the service node in the second service network.

In some embodiments, as shown in FIG. 8, the multi-blockchain involved in some embodiments further includes the target main chain independent of the first main chain, the second main chain, and a target subchain. A target network corresponding to the target main chain is a consensus network independent of the first network, and a second network corresponding to the second main chain is a consensus network independent of the first network. A target subnetwork corresponding to the target subchain is created by a target consensus node in the target network based on a third service requested by a third service object in the service object. A consensus node in the target subnetwork includes a consensus node selected from the first network and a consensus node selected from the second network. A service network associated with the target subnetwork is a third service network. After performing the foregoing operation 202, the first consensus node may further perform the following operation 207 to operation 208 based on the identified node identity of the service clearing node.

Operation 207: Invoke, when the identity authority verification result indicates that the service clearing node is a third-type clearing node corresponding to the third service object, and node authority of the third-type clearing node is the second-type clearing authority, the first authority clearing contract associated with the first authority contract to obtain second core data of the first service data associated with the second-type clearing node from the first main chain.

For example, the second-type clearing node is a service node in the third service network. The second core data is partial data visible to the third service object corresponding to the third-type clearing node in the first service data. The second-type clearing authority represents that the third-type clearing node originating from the third service network has authority to obtain local data in the first service data from the first main chain and the second-type clearing node has authority to obtain third service data different from the first service data from the target subchain.

Operation 208: Use the second core data of the first service data as third clearing response information corresponding to the clearing transaction request, and return the third clearing response information to the second-type clearing node having the second-type clearing authority.

For example, a service node 84a in a third service network may access the first network through the first chain entrance and may perform, through the first chain entrance, preliminary access authentication on an SPV node originating from the third service network. When the access authentication succeeds, the SPV nodes accesses the first network, and the first consensus node invokes the first authority contract (for example, the electronic bill node authority contract deployed on the bill chain in the embodiment corresponding to FIG. 2, for example, an electronic invoice SPV authority contract) on the first main chain to perform identity authority verification (for example, perform the identity verification and the authority verification) on the SPV node originating from the third service network.

For implementation details of performing, through the first chain entrance, preliminary access authentication on the SPV node originating from the third service network, reference may be made to the descriptions of access authentication and FIG. 3. The first consensus node may determine, based on the first authority contract on the first main chain, that the SPV node originating from the third service network is the foregoing third-type clearing node, and node authority of the third-type clearing node is the foregoing second-type clearing authority. In this case, the first consensus node may further invoke the first authority clearing contract on the first main chain to obtain second core data of first service data associated with the second-type clearing node from the first main chain, and then may return the second core data to the third-type clearing node through a data clearing interface of a second application contract deployed on a target subchain shown in FIG. 8. In this case, the service node 84a deployed in the third service network may obtain, from the first main chain, core data (for example, the foregoing second core data, where the second core data herein may be a bill issuance amount of an enterprise A in the electronic bill, which helps perform risk control and management subsequently on the enterprise A based on the bill issuance amount of the enterprise A obtained through statistics collection) in an electronic bill visible to a third service object corresponding to the service node 84a.

When obtaining the core data (for example, the foregoing second core data, where the second core data herein may be a bill issuance amount of an enterprise A in the electronic bill) in the electronic bill, the service node 84a deployed in the third service network may submit a third transaction chaining request (for example, the third transaction chaining request herein may be configured to instruct a sub-consensus node on the target subchain to accumulate the bill issuance amount of the enterprise A, and may perform risk control and management on the enterprise A based on the accumulated bill issuance amount of the enterprise A) to the target subchain shown in FIG. 8 based on the obtained core data in the electronic bill, to enable a target sub-consensus node on the target subchain to invoke, after obtaining the third transaction chaining request through a second chain entrance, a third authority contract on the target subchain to determine service processing authority of the third service object initiating the third transaction chaining request. When it is determined that the third service object has the service processing authority to process a third service, the third service may be written into the second application contract on the target subchain. The target sub-consensus node may further invoke a first service execution method in the second application contract to execute the third service, to obtain a third service execution result corresponding to the third service, and use the third service execution result as the third service data associated with the third-type clearing node. The target sub-consensus node may further generate a third chaining transaction corresponding to a third to-be-chained transaction based on the third service data and a node identifier of the service node 84a, and write a third target block including the third chaining transaction into the target subchain. For implementation details of how the service node 84a deployed in the third service network clears, from the target subchain, the third service data associated with the service node 83a, third ledger data corresponding to the third service data, and third contract data corresponding to the third ledger data, reference may be made to the descriptions in which the service node in the first service network clears the first service data associated with the service node from the first main chain, the first ledger data corresponding to the first service data, and the first contract data corresponding to the first ledger data.

In some embodiments, after the third clearing response information is returned to the third-type clearing node having the second-type clearing authority, when the third-type clearing node generates a third transaction chaining request associated with the third service based on the third clearing response information, the third-type clearing node may transmit the third transaction chaining request to a sub-consensus node that has an association with the first consensus node and that is in the target subnetwork. When determining, based on the third transaction chaining request, that the third service object has service processing authority to process the third service, the sub-consensus node having an association with the first consensus node may invoke a third service contract on the target subchain to execute the third service, to use a third service execution result obtained by executing the third service as the third service data.

When being the foregoing service clearing nodes of a cross-chain type, a service node in the second service network and a service node in the third service network can both obtain core data (for example, the core data in the foregoing electronic bill) in the first service data visible to the service node in the second service network and the service node in the third service network from the first main chain, to carry out another service associated with the first service on a corresponding blockchain by using the core data (for example, the core data in the foregoing electronic bill) in the first service data obtained from the first main chain. In addition, when being the foregoing service clearing nodes of a non-cross-chain type, a service node in the second service network and a service node in the third service network can also both obtain service data, ledger data, and contract data visible to the service node in the second service network and the service node in the third service network from a corresponding blockchain. In view of the above, in some embodiments, based on different node identities of service nodes in a service network, data matching the node identities and node authority of the service nodes can be flexibly cleared from a corresponding blockchain. In some embodiments, service nodes of different types are arranged, and the service nodes may selectively recover corresponding sub-ledgers locally based on their different node identities. When a network participant directly performs data exchanging with a service node of a corresponding type, efficiency of obtaining corresponding data can be improved from the root.

In some embodiments, a node identity of a service clearing node transmitting a first transaction clearing request may be intelligently identified through the target node identifier written into the first authority contract on the first main chain, and the node authority corresponding to the node identity can be quickly determined based on the node identity (for example, the foregoing first-type clearing node, the foregoing second-type clearing node, or the foregoing third-type clearing node) intelligently identified, and service data matching the node authority of the corresponding service clearing node may be obtained from the first main chain. For example, for the first-type clearing node, the first service data, the first ledger data, and the first contract data may be obtained from the first main chain. However, for the second-type clearing node and the third-type clearing node, to ensure security of on-chain data, a service node originating from the second service network and a service node originating from the third service network may clear core data in first service data related to the service nodes from the first main chain. For example, in some embodiments, data security during data clearing may be improved based on an identity authority mechanism. In addition, since the first service data on the first main chain is only visible to a service object corresponding to the first-type clearing node, it may be difficult for a service clearing node of another node identity to directly obtain the first service data from the first main chain. Some embodiments can further ensure privacy and security isolation of the on-chain data on the first main chain from the root.

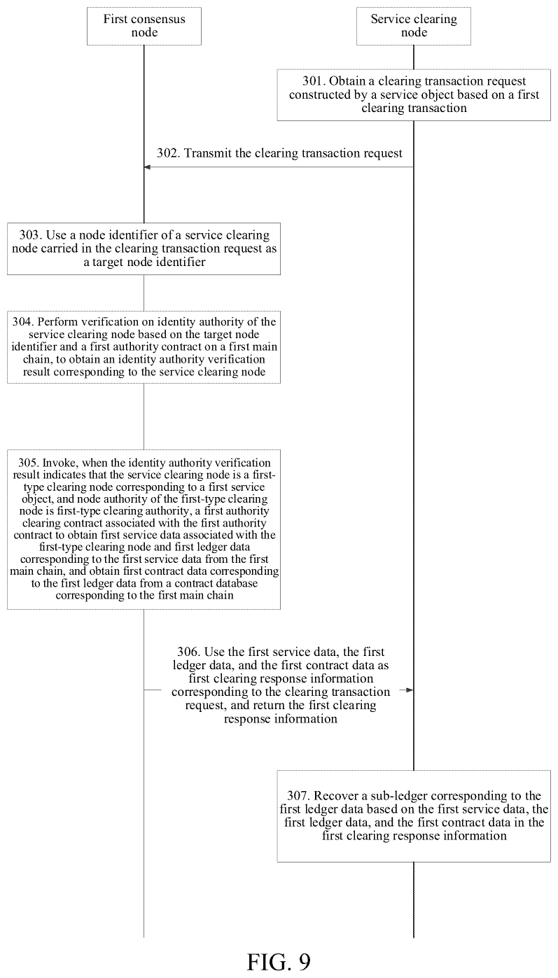

Referring to FIG. 9, FIG. 9 is a timing diagram of a data processing method based on a multi-blockchain according to some embodiments. As shown in FIG. 9, the method may be jointly performed by a first consensus node in the foregoing first network and a service clearing node in a service network through interaction. For example, the first consensus node may be any consensus node in the consensus network A22 shown in FIG. 1, and the service clearing node may be any service node in the service network A21 in FIG. 1. The method may include the following operations.

Operation 301: The service clearing node obtains a clearing transaction request constructed by a service object based on a first clearing transaction. The service object includes a first service object.

Operation 302: The service clearing node transmits the clearing transaction request to the first consensus node in the first network.

Operation 303: When the first consensus node obtains the clearing transaction request submitted by the service object through the service clearing node, the first consensus node uses a node identifier of the service clearing node carried in the clearing transaction request as a target node identifier. The service object includes a first service object associated with a first service network. The first service network is a service network associated with the first network.

Operation 304: The first consensus node may perform verification on identity authority of the service clearing node based on the target node identifier and a first authority contract on a first main chain, to obtain an identity authority verification result corresponding to the service clearing node.

For example, the identity authority verification result is configured for generating first clearing response information when the first consensus node determines that the service clearing node is a first-type clearing node corresponding to the first service object, and node authority of the first-type clearing node is first-type clearing authority.

Operation 305: The first consensus node invokes, when the identity authority verification result indicates that the service clearing node is a first-type clearing node corresponding to the first service object, and node authority of the first-type clearing node is first-type clearing authority, a first authority clearing contract associated with the first authority contract to obtain first service data associated with the first-type clearing node and first ledger data corresponding to the first service data from the first main chain, and obtains first contract data corresponding to the first ledger data from a contract database corresponding to the first main chain.

For example, the first-type clearing node is a service node in the first service network. The first-type clearing authority represents that the first-type clearing node originating from the first service network has data obtaining authority, the data obtaining authority being authority to obtain the first service data visible to the first service object from the first main chain.

Operation 306: The first consensus node uses the first service data, the first ledger data, and the first contract data as first clearing response information corresponding to the clearing transaction request, and returns the first clearing response information to the first-type clearing node having the first-type clearing authority.

For example, the first clearing response information includes the first service data, first ledger data corresponding to the first service data, and first contract data corresponding to the first ledger data. The first service data is service data associated with the first-type clearing node. The service data associated with the first-type clearing node is obtained from the first main chain by the first consensus node by invoking a first authority clearing contract associated with the first authority contract. The first contract data corresponding to the first ledger data is contract data obtained by the first consensus node from a contract database corresponding to the first main chain by invoking the first authority clearing contract.

Operation 307: The service clearing node recovers, when receiving the first clearing response information returned by the first consensus node, a sub-ledger corresponding to the first ledger data based on the first service data, the first ledger data, and the first contract data in the first clearing response information.

In some embodiments, a node identity of a service clearing node transmitting a first transaction clearing request may be intelligently identified through the target node identifier written into the first authority contract on the first main chain, and the node authority corresponding to the node identity can be quickly determined based on the node identity (for example, the foregoing first-type clearing node, the foregoing second-type clearing node, or the foregoing third-type clearing node) intelligently identified, and service data matching the node authority of the corresponding service clearing node may be obtained from the first main chain. For example, for the first-type clearing node, the first service data, the first ledger data, and the first contract data may be obtained from the first main chain. However, for the second-type clearing node and the third-type clearing node, to ensure security of on-chain data, a service node originating from the second service network and a service node originating from the third service network may clear core data in first service data related to the service nodes from the first main chain. For example, in some embodiments, data security during data clearing can be improved based on an identity authority mechanism. In addition, since the first service data on the first main chain is only visible to a service object corresponding to the first-type clearing node, it may be difficult for a service clearing node of another node identity to directly obtain the first service data from the first main chain. Some embodiments may further ensure privacy and security isolation of the on-chain data on the first main chain from the root.

For all data involved in some embodiments, when some embodiments are applied to a product or technology, a permission or an approval from a user may be obtained. In addition, collection, use, and processing of related data should comply with relevant laws, regulations, and standards of relevant countries and regions.

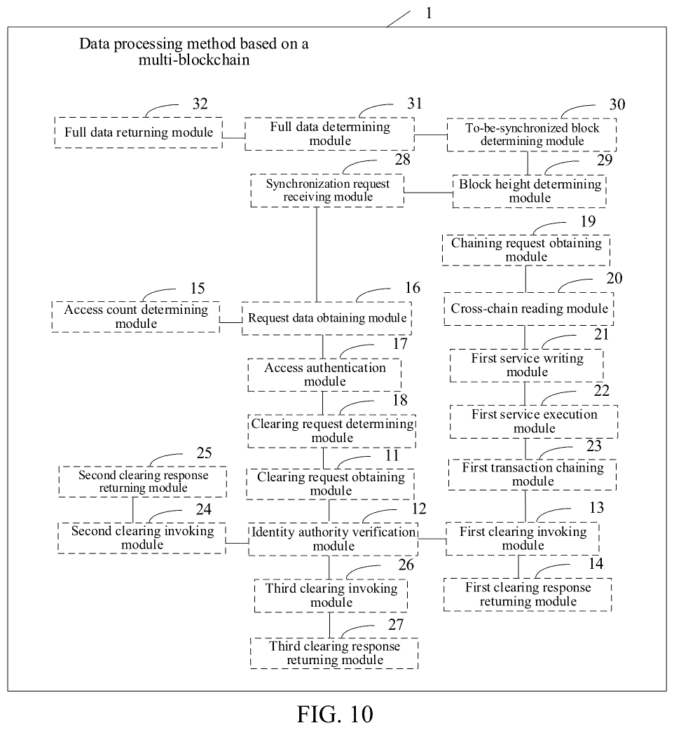

Referring to FIG. 10, FIG. 10 is a schematic structural diagram of a data processing apparatus based on a multi-blockchain according to some embodiments. As shown in FIG. 10, a data processing apparatus 1 based on a multi-blockchain may be used in a first consensus node. The first consensus node may be any blockchain node in a first network (for example, the foregoing consensus network A22). For example, the first consensus node may be the foregoing consensus node 11c in the embodiment corresponding to FIG. 1. The data processing apparatus 1 based on a multi-blockchain may be a computer program (including program code) run on a blockchain node (for example, the foregoing consensus node 11c). For example, the data processing apparatus 1 based on a multi-blockchain may be application software. The data processing apparatus 1 based on a multi-blockchain may be configured to perform the corresponding operations in the method provided in some embodiments. As shown in FIG. 9, the data processing apparatus based on a multi-blockchain 1 may include: a clearing request obtaining module 11, an identity authority verification module 12, a first clearing invoking module 13, and a first clearing response returning module 14.

The clearing request obtaining module 11 is configured to use, when obtaining a clearing transaction request submitted by a service object through a service clearing node, a node identifier of the service clearing node carried in the clearing transaction request as a target node identifier. The service object includes a first service object associated with a first service network. The first service network is a service network associated with the first network.

The identity authority verification module 12 is configured to perform verification on identity authority of the service clearing node based on the target node identifier and a first authority contract on the first main chain, to obtain an identity authority verification result corresponding to the service clearing node.

The first clearing invoking module 13 is configured to invoke, when the identity authority verification result indicates that the service clearing node is a first-type clearing node corresponding to the first service object, and node authority of the first-type clearing node is first-type clearing authority, a first authority clearing contract associated with the first authority contract to obtain first service data associated with the first-type clearing node and first ledger data corresponding to the first service data from the first main chain, and obtain first contract data corresponding to the first ledger data from a contract database corresponding to the first main chain. The first-type clearing node is a service node in the first service network. The first-type clearing authority represents that the first-type clearing node originating from the first service network has data obtaining authority, the data obtaining authority being authority to obtain the first service data visible to the first service object from the first main chain.

The first clearing response returning module 14 is configured to use the first service data, the first ledger data, and the first contract data as first clearing response information corresponding to the clearing transaction request, and return the first clearing response information to the first-type clearing node having the first-type clearing authority, to cause the first-type clearing node to recover a sub-ledger corresponding to the first ledger data based on the first clearing response information.

For example, implementation details of the clearing request obtaining module 11, the identity authority verification module 12, the first clearing invoking module 13, and the first clearing response returning module 14, reference may be made to the descriptions of operation 101 to operation 104 and FIG. 3.

In some embodiments, the multi-blockchain further includes a target main chain independent of the first main chain. A chain entrance corresponding to the first network is a first chain entrance. The first chain entrance has a chain access count threshold corresponding to the first main chain and authorized access data information stored therein. The authorized access data information is authorized access data information that is of an authorized object allowed to access the first main chain and that is obtained by the first consensus node from the target main chain. The authorized access data information is generated by a target consensus node based on object data information. The target consensus node is associated with the target main chain, and the object data information is submitted by the authorized object. The chain access count threshold represents a maximum concurrent request access count obtained through the first chain entrance.

The apparatus 1 further includes: an access count determining module 15, a request data obtaining module 16, an access authentication module 17, and a clearing request determining module 18.

The access count determining module 15 is configured to increment, when obtaining, through the first chain entrance, a data clearing transaction request submitted by the service object through the service clearing node, a request access count of the first chain entrance based on the data clearing transaction request, to obtain an incremented request access count.

The request data obtaining module 16 is configured to obtain, when the incremented request access count does not reach the chain access count threshold, access request data information associated with the service object from the data clearing transaction request.

The access authentication module 17 is configured to perform, based on the authorized access data information, access authentication on the service object submitting the access request data information, to obtain an access authentication result of the service object.

The clearing request determining module 18 is configured to determine, when the access authentication result indicates that the access request data information is consistent with access registration data information in the authorized access data information, the service object as the authorized object, and uses the data clearing transaction request submitted by the service object as the clearing transaction request.

For example, implementation details of the access count determining module 15, the request data obtaining module 16, the access authentication module 17, and the clearing request determining module 18, reference may be made to the descriptions of determining a clearing transaction request and FIG. 3.

In some embodiments, the authorized access data information stored in the first chain entrance carries public key information of the service object. The data clearing transaction request carries object signature information of the service object. The object signature information is obtained after the service clearing node performs, based on private key information of the service object, signature addition on a first clearing transaction requested by the service object. The private key information of the service object and the public key information of the service object form a key pair with each other, and the private key information of the service object and the public key information of the service object are both configured by the target consensus node based on the object data information submitted by the service object.

The request data obtaining module 16 includes: a signature information obtaining unit and a signature verification success unit.

The signature information obtaining unit is configured to obtain the object signature information from the data clearing transaction request, and perform signature verification on the object signature information based on the public key information of the service object stored in the first chain entrance, to obtain a signature verification result.

The signature verification success unit is configured to obtain, when the signature verification result indicates that the signature verification succeeds, the first clearing transaction carried in the data clearing transaction request, and use access data information corresponding to the first clearing transaction as the access request data information associated with the service object.

For example, implementation details of the signature information obtaining unit and the signature verification success unit, reference may be made to the descriptions of signature verification and FIG. 3.

In some embodiments, the request data obtaining module 16 further includes a signature verification failure unit.

The signature verification failure unit is configured to determine, when the signature verification result indicates that the signature verification fails, the service object as an invalid object, and reject the data clearing transaction request transmitted by the invalid object.

For example, for implementation details of the signature verification failure unit, reference may be made to the descriptions of signature verification and FIG. 3.

In some embodiments, the identity authority verification module 12 includes a node identifier writing unit, an identity verification unit, authority verification unit, and a verification result determining unit.

The node identifier writing unit is configured to write the target node identifier into the first authority contract on the first main chain.

The identity verification unit is configured to invoke a first identity verification method in the first authority contract to perform identity verification on the service clearing node having the target node identifier, to obtain an identity verification result.

The authority verification unit is configured to use, when the identity verification result indicates that a node identity of the service clearing node is of a first identity type, the service clearing node corresponding to the first identity type as the first-type clearing node, and invoke a first authority verification method in the first authority contract to perform authority verification on the service clearing node having the target node identifier, to obtain an authority verification result.

The verification result determining unit is configured to use, when the authority verification result indicates that node authority of the service clearing node is the first-type clearing authority, the first-type clearing node having the first-type clearing authority as the identity authority verification result corresponding to the service clearing node.

For example, for implementation details of the node identifier writing unit, the identity verification unit, the authority verification unit, and the verification result determining unit, reference may be made to the descriptions of verifying a node identity and node authority and FIG. 3 . . .

In some embodiments, a block to which the first service data belongs is a first target block on the first main chain. A first chaining transaction to which the first service data belongs includes a node identifier of the first-type clearing node. The node identifier of the first-type clearing node is the target node identifier. The target node identifier represents that the first chaining transaction in the first target block is visible to the first service object corresponding to the first-type clearing node.

The first clearing invoking module 13 includes a clearing contract accessing unit, a first ledger data obtaining unit, and a first contract data obtaining unit.

The clearing contract accessing unit is configured to invoke a data clearing method in the first authority contract, access the first authority clearing contract, write the target node identifier into the first authority clearing contract, invoke the first authority clearing contract to obtain the first target block associated with the first-type clearing node from the first main chain, obtain the first chaining transaction visible to the first-type clearing node from the first target block, and obtain the first service data corresponding to the target node identifier from the first chaining transaction.

The first ledger data obtaining unit is configured to obtain, from a ledger database corresponding to the first main chain, ledger data associated with the first service data as the first ledger data.

The first contract data obtaining unit is configured to obtain, from a contract database corresponding to the first main chain, contract data associated with the first service data as the first contract data corresponding to the first ledger data.

For example, for implementation details of the clearing contract accessing unit, the first ledger data obtaining unit, and the first contract data obtaining unit, reference may be made to the descriptions of obtaining first ledger data and first contract data and FIG. 3.

In some embodiments, the chain entrance corresponding to the first network is the first chain entrance, and the multi-blockchain further includes the target main chain independent of the first main chain.

The apparatus 1 further includes a chaining request obtaining module 19, a cross-chain reading module 20, a first service writing module 21, a first service execution module 22, and a first transaction chaining module 23.

The chaining request obtaining module 19 is configured to obtain a first transaction chaining request through the first chain entrance, and obtain, from the first transaction chaining request, a first service requested by the first service object and a first to-be-chained transaction corresponding to the first service, the first transaction chaining request being transmitted by the first service object through the first-type clearing node.

The cross-chain reading module 20 is configured to write the first to-be-chained transaction into the first authority contract, invoke a second authority verification method in the first authority contract, access a first cross-chain reading contract on the first main chain, and read service processing authority verification information associated with the first service across chains from the target main chain based on the first cross-chain reading contract.

The first service writing module 21 is configured to write the first service into a first service contract on the first main chain when determining, based on the service processing authority verification information, that the service object has service processing authority to process the first service.

The first service execution module 22 is configured to invoke a first service execution method in the first service contract to execute the first service, to obtain a first service execution result corresponding to the first service, and use the first service execution result as the first service data associated with the first-type clearing node.

The first transaction chaining module 23 is configured to generate the first chaining transaction corresponding to the first to-be-chained transaction based on the first service data and the target node identifier, and write the first target block including the first chaining transaction into the first main chain.

For example, for implementation details of the chaining request obtaining module 19, the cross-chain reading module 20, the first service writing module 21, the first service execution module 22, and the first transaction chaining module 23, reference may be made to the descriptions of writing a first target block into a first main chain and FIG. 3.

In some embodiments, the first service includes an electronic bill issuance service, and the first service contract includes an electronic bill issuance contract.

The first service execution module 22 include a bill issuance contract accessing unit and a first service data determining unit.

The bill issuance contract accessing unit is configured to invoke a subcontract accessing method in the first service contract to access the electronic bill issuance contract, and execute the electronic bill issuance service in the first service based on the first service execution method in the electronic bill issuance contract, to obtain a target electronic bill issued for the service object. The target electronic bill is the first service execution result corresponding to the first service.

The first service data determining unit is configured to use the first service execution result as the first service data associated with the first-type clearing node.

For example, for implementation details of the bill issuance contract accessing unit and the first service data determining unit, reference may be made to the descriptions of the target electronic bill and FIG. 3.

In some embodiments, the first target block includes a second chaining transaction other than the first chaining transaction. The second chaining transaction is a transaction invisible to the first service object corresponding to the first-type clearing node in the first target block.

The first transaction chaining module 23 is further configured to use, when the first target block is written to the first main chain, a block header of the first target block, data content of the first service data belonging to the first chaining transaction, an associated state root associated with the second chaining transaction, and a Merkle verification path configured to assist in performing verification on the first service data as the first ledger data corresponding to the first target block, and add the first ledger data to the ledger database corresponding to the first main chain.

The first transaction chaining module 23 is further configured to use a contract name, a contract method, and a contract address of a first service contract invoked for executing the first service as first contract data corresponding to the first ledger data, and add the first contract data to a contract database corresponding to the first main chain.

In some embodiments, the first ledger data obtaining unit may be configured to search the ledger database corresponding to the first main chain for the block header of the first target block, the data content of the first service data belonging to the first chaining transaction, the associated state root associated with the second chaining transaction, and the Merkle verification path configured to assist in performing verification on the first service data.

The first ledger data obtaining unit may be further configured to use the block header of the first target block, the data content of the first service data, the associated state root, and the Merkle verification path that are found as the ledger data associated with the first service data obtained from the ledger database corresponding to the first main chain.

The first ledger data obtaining unit is further configured to use the ledger data associated with the first service data as the first ledger data.

In some embodiments, the first contract data obtaining unit may be configured to search the contract database corresponding to the first main chain for the contract name, the contract method, and the contract address of the first service contract invoked for executing the first service.

The first contract data obtaining unit may further be configured to use the contract name of the first service contract, the contract method of the first service contract, and the contract address of the first service contract that are found as the contract data associated with the first service data obtained from the contract database corresponding to the first main chain.

The first contract data obtaining unit is further configured to use the contract data associated with the first service data as the first contract data corresponding to the first ledger data.

In some embodiments, the multi-blockchain further includes a second main chain independent of the first main chain, and a chain entrance of the second main chain is a second chain entrance. A second network corresponding to the second main chain is a consensus network independent of the first network. A service network associated with the second network is a second service network. The service object includes a second service object.

The apparatus 1 further includes a second clearing invoking module 24 and a second clearing response returning module 25.

The second clearing invoking module 24 is configured to invoke, when the identity authority verification result indicates that the service clearing node is a second-type clearing node corresponding to the second service object, and node authority of the second-type clearing node is second-type clearing authority, the first authority clearing contract associated with the first authority contract to obtain first core data of the first service data associated with the second-type clearing node from the first main chain. The second-type clearing node is a service node in a second service network. The first core data is partial data visible to the second service object corresponding to the second-type clearing node in the first service data. The second-type clearing authority represents that the second-type clearing node originating from the second service network has local data obtaining authority, the local data obtaining authority being authority to obtain local data in the first service data from the first main chain and authority of the second-type clearing node to obtain second service data different from the first service data from the second main chain.

The second clearing response returning module 25 is configured to use the first core data of the first service data as second clearing response information corresponding to the clearing transaction request, and return the second clearing response information to the second-type clearing node having the second-type clearing authority.

The second-type clearing node transmits, when generating, based on the second clearing response information, a second transaction chaining request associated with a second service, the second transaction chaining request through the second chain entrance to a second consensus node in the second network corresponding to the second main chain through the second chain entrance. The second network is a consensus network independent of the first network. The second consensus node invokes, when determining, based on the second transaction chaining request, that the second service object has service processing authority to process the second service, a second service contract on the second main chain to execute the second service, to use a second service execution result obtained by executing the second service as the second service data.

For example, for implementation details of the second clearing invoking module 24 and the second clearing response returning module 25, reference may be made to the descriptions of the second-type clearing node and FIGS. 3 and 7.

In some embodiments, the multi-blockchain further includes the target main chain independent of the first main chain, the second main chain, and a target subchain. A target network corresponding to the target main chain is a consensus network independent of the first network, and a second network corresponding to the second main chain is a consensus network independent of the first network. A target subnetwork corresponding to the target subchain is created by a target consensus node in the target network based on a third service requested by a third service object in the service object. A consensus node in the target subnetwork includes a consensus node selected from the first network and a consensus node selected from the second network. A service network associated with the target subnetwork is a third service network.

The apparatus 1 further includes a third clearing invoking module 26 and a third clearing response returning module 27.

The third clearing invoking module 26 is configured to invoke, when the identity authority verification result indicates that the service clearing node is a third-type clearing node corresponding to the third service object, and node authority of the third-type clearing node is the second-type clearing authority, the first authority clearing contract associated with the first authority contract to obtain second core data of the first service data associated with the second-type clearing node from the first main chain. The second-type clearing node is a service node in the third service network. The second core data is partial data visible to the third service object corresponding to the third-type clearing node in the first service data. The second-type clearing authority represents that the third-type clearing node originating from the third service network has authority to obtain local data in the first service data from the first main chain and the second-type clearing node has authority to obtain third service data different from the first service data from the target subchain.

The third clearing response returning module 27 is configured to use the second core data of the first service data as third clearing response information corresponding to clearing transaction request, and return the third clearing response information to the third-type clearing node having the second-type clearing authority, to cause the third-type clearing node to transmit, when generating a third transaction chaining request associated with the third service based on the third clearing response information, the third transaction chaining request to a sub-consensus node that has an association with the first consensus node and that is in the target subnetwork. The sub-consensus node invokes, when determining, based on the third transaction chaining request, that the third service object has service processing authority to process the third service, a third service contract on the target subchain to execute the third service, to use a third service execution result obtained by executing the third service as the third service data.

For example, for implementation details of the third clearing invoking module 26 and the third clearing response returning module 27, reference may be made to the descriptions of the third-type clearing node and FIGS. 3 and 7.

In some embodiments, a ledger interface corresponding to the first network is a first ledger interface.

The apparatus 1 further includes a synchronization request receiving module 28, a block height determining module 29, a to-be-synchronized block determining module 30, a full data determining module 31, and a full data returning module 32.

The synchronization request receiving module 28 is configured to obtain a block synchronization request through the first ledger interface, and obtain, from the block synchronization request, a first block height submitted by a service synchronization object. The block synchronization request is transmitted by the service synchronization object through a service synchronization node, and the first block height is a block height of a first block in a local blockchain locally stored on the service synchronization node. The first block is a block with a maximum block height on the local blockchain.

The block height determining module 29 is configured to use a block with a maximum block height on the first main chain as a second block, and using a block height of the second block as a second block height.

The to-be-synchronized block determining module 30 is configured to obtain, when the second block height is greater than the first block height, a block between the first block height and the second block height from the first main chain as a to-be-synchronized block.

The full data determining module 31 is configured to determine full ledger data and full contract data corresponding to the full ledger data based on the to-be-synchronized block, the full ledger data and the full contract data being configured to be transmitted to the service synchronization node.

The full data returning module 32 is configured to return the full ledger data and the full contract data to the service synchronization node when returning the to-be-synchronized block the service synchronization node, to cause the service synchronization node to locally construct, when adding the to-be-synchronized block to the local blockchain, local full ledger data corresponding to the full ledger data and local full contract data corresponding to the full contract data synchronously.

For example, for implementation details of the synchronization request receiving module 28, the block height determining module 29, the to-be-synchronized block determining module 30, the full data determining module 31, and the full data returning module 32, reference may be made to the descriptions of the first ledger interface and FIG. 7.

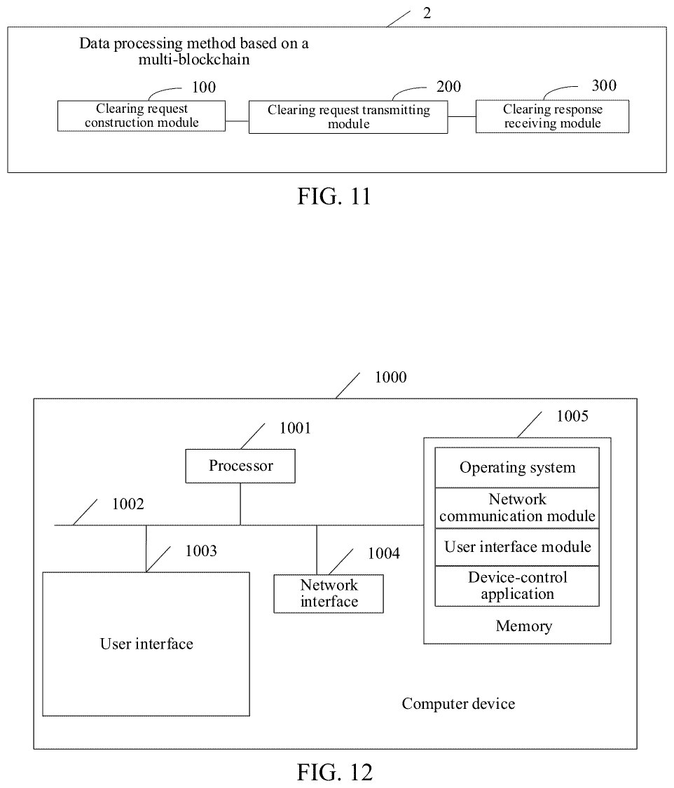

Referring to FIG. 11, FIG. 11 is a schematic structural diagram of a data processing apparatus based on a multi-blockchain according to some embodiments. As shown in FIG. 11, a data processing apparatus 2 based on a multi-blockchain may be used in a service clearing node in a service network. The service network includes a first service network associated with a first network. The service clearing node may be any blockchain node in the first service network (for example, the foregoing service network A21). For example, the service clearing node may be the foregoing service node 110c in the embodiment corresponding to FIG. 1. The data processing apparatus 2 based on a multi-blockchain may be a computer program (including program code) run on a blockchain node (for example, the foregoing service node 110c). For example, the data processing apparatus 2 based on a multi-blockchain may be application software. The data processing apparatus 2 based on a multi-blockchain may be configured to perform the corresponding operations in the method provided in some embodiments. As shown in FIG. 8, the data processing apparatus 2 based on a multi-blockchain may include a clearing request construction module 100, a clearing request transmitting module 200, and a clearing response receiving module 300.

The clearing request construction module 100 is configured to obtain a clearing transaction request constructed by a service object based on a first clearing transaction. The service object includes a first service object.

The clearing request transmitting module 200 is configured to transmit the clearing transaction request to a first consensus node in the first network, to cause the first consensus node to perform verification on identity authority of the service clearing node based on a node identifier of the service clearing node carried in the clearing transaction request and a first authority contract on the first main chain, to obtain an identity authority verification result corresponding to the service clearing node. The identity authority verification result being configured for generating first clearing response information when the first consensus node determines that the service clearing node is a first-type clearing node corresponding to the first service object, and node authority of the first-type clearing node is first-type clearing authority, the first-type clearing node being a service node in the first service network, the first-type clearing authority representing that the first-type clearing node originating from the first service network has data obtaining authority. The data obtaining authority is authority to obtain the first service data visible to the first service object from the first main chain. The first clearing response information includes the first service data, first ledger data corresponding to the first service data, and first contract data corresponding to the first ledger data. The first service data is service data associated with the first-type clearing node. The service data associated with the first-type clearing node is obtained from the first main chain by the first consensus node by invoking a first authority clearing contract associated with the first authority contract. The first contract data corresponding to the first ledger data is contract data obtained by the first consensus node from a contract database corresponding to the first main chain by invoking the first authority clearing contract.

The clearing response receiving module 300 is configured to receive the first clearing response information returned by the first consensus node, and recover a sub-ledger corresponding to the first ledger data based on the first service data, the first ledger data, and the first contract data in the first clearing response information.

For example, for implementation details of the clearing request construction module 100, the clearing request transmitting module 200, and the clearing response receiving module 300, reference may be made to the descriptions of the service clearing node and FIGS. 3, 7, and 9.

According to some embodiments, each module or unit may exist respectively or be combined into one or more units. Some modules or units may be further split into multiple smaller function subunits, thereby implementing the same operations without affecting the technical effects of some embodiments. The modules or units are divided based on logical functions. In actual applications, a function of one module or unit may be realized by multiple modules or units, or functions of multiple modules or units may be realized by one module or unit. In some embodiments, the apparatus may further include other modules or units. In actual applications, these functions may also be realized cooperatively by the other modules or units, and may be realized cooperatively by multiple modules or units.

A person skilled in the art would understand that these “modules” or “units” could be implemented by hardware logic, a processor or processors executing computer software code, or a combination of both. The “modules” or “units” may also be implemented in software stored in a memory of a computer or a non-transitory computer-readable medium, where the instructions of each unit are executable by a processor to thereby cause the processor to perform the respective operations of the corresponding module or unit.

Referring to FIG. 12, FIG. 12 is a schematic structural diagram of an electronic device according to some embodiments. As shown in FIG. 12, an electronic device 1000 may be a user terminal or a server, which is not limited herein. In some embodiments, using an example in which an electronic device is a server, the electronic device 1000 may include a processor 1001, a network interface 1004, and a memory 1005. In addition, the electronic device 1000 may further include a user interface 1003 and at least one communication bus 1002. The communication bus 1002 is configured to implement connection and communication between the components. The user interface 1003 may further include a standard wired interface and wireless interface. In some embodiments, the network interface 1004 may include a standard wired interface and a standard wireless interface (such as a Wi-Fi interface). The memory 1005 may be a high-speed random access memory (RAM), or may be a non-volatile memory, for example, at least one magnetic disk memory. In some embodiments, the memory 1005 may be at least one storage apparatus that is located far away from the foregoing processor 1001. As shown in FIG. 12, the memory 1005 used as a computer-readable storage medium may include an operating system, a network communication module, a user interface module, and a device-control application.

For example, the network interface 1004 in the electronic device 1000 may further provide a network communication function. In the electronic device 1000 shown in FIG. 12, the network interface 1004 may provide a network communication function. The user interface 1003 is configured to provide an input interface for a user. The processor 1001 may be configured to invoke the device-control application stored in the memory 1005 to perform the foregoing descriptions of the data processing method based on a multi-blockchain in the embodiment corresponding to FIG. 3, FIG. 7, or FIG. 9, and may further perform the foregoing descriptions of the data processing apparatus based on a multi-blockchain (for example, the foregoing data processing apparatus 1 based on a multi-blockchain or the data processing apparatus 2 based on a multi-blockchain) in some embodiments as illustrated in FIG. 10 or FIG. 11, for example.

In addition, some embodiments further provide a computer-readable storage medium. The computer-readable storage medium has a computer program product executed by the data processing apparatus 1 based on a multi-blockchain or the data processing apparatus 2 based on a multi-blockchain that is mentioned above stored therein, and the computer program product includes computer-executable instructions. When executing the computer-executable instructions, the processor may perform the operations of the data processing method based on a multi-blockchain as illustrated in FIG. 3, FIG. 7, or FIG. 9, for example. For implementation details of the computer-readable storage medium included in some embodiments, reference may be made to the descriptions of the method according to some embodiments. In an example, the computer-executable instructions may be deployed for execution on one electronic device, execution on a plurality of electronic devices located at one location, or execution on a plurality of electronic devices that are distributed at a plurality of locations and that are interconnected through a communication network. The plurality of electronic devices that are distributed at a plurality of locations and that are interconnected through a communication network can form a blockchain system.

In addition, some embodiments further provide a computer program product. The computer program product may include computer-executable instructions. The computer-executable instructions may be stored in a computer-readable storage medium. A processor of an electronic device reads the computer-executable instructions from the computer-readable storage medium, and the processor may execute the computer-executable instructions, to cause the electronic device to execute the descriptions of the data processing method based on a multi-blockchain in some embodiments as illustrated in FIG. 3, FIG. 7, or FIG. 9, for example. For implementation details of the computer program product in some embodiments, reference may be made to the descriptions of the method according to some embodiments.

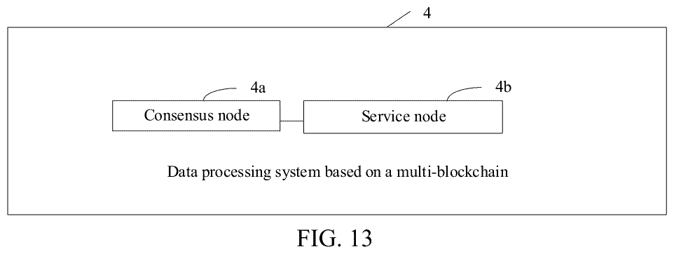

Referring to FIG. 13, FIG. 13 is a schematic diagram of a data processing system based on a multi-blockchain according to some embodiments. A data processing system 4 based on a multi-blockchain may include a consensus node 4a and a service node 4b. The consensus node 4a may be the first consensus node in the first network described in the embodiment corresponding to FIG. 3. The first consensus node may be any blockchain node in the consensus network A22 shown in FIG. 1. The service node 4b may be a service node in the first service network described in the embodiment corresponding to FIG. 3. The service node may be any blockchain node in the service network A21 shown in FIG. 1, for example.

A person of ordinary skill in the art may understand that all or some of the procedures of the methods of the foregoing embodiments may be implemented by computer-executable instructions instructing relevant hardware. The computer-executable instructions may be stored in a computer-readable storage medium. When the program is executed, the program may include the procedures of the embodiments of the foregoing methods. The storage medium may be a magnetic disc, an optical disc, a read-only memory (ROM), a random access memory (RAM), or the like.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A data processing method performed by a first consensus node in a first network of a multi-blockchain, comprising:
obtaining, through a service clearing node, a clearing transaction request submitted by a service object comprising a first service object associated with a first service network, wherein the first service network is associated with the first network, and the first network is a consensus network corresponding to a first main chain of the multi-blockchain;
using a node identifier of the service clearing node carried in the clearing transaction request as a target node identifier;
performing verification on an identity authority of the service clearing node based on the target node identifier and a first authority contract on the first main chain, to obtain an identity authority verification result corresponding to the service clearing node;
invoking a first authority clearing contract associated with the first authority contract to obtain first service data associated with a first-type clearing node corresponding to the first service object that is a service node in the first service network and first ledger data corresponding to the first service data from the first main chain, based on:
the identity authority verification result indicating the service clearing node is the first-type clearing node, and
a node authority of the first-type clearing node being a first-type clearing authority indicating the first-type clearing node has data obtaining authority to obtain the first service data which is visible to the first service object from the first main chain;
obtaining first contract data corresponding to the first ledger data from a contract database corresponding to the first main chain;
using the first service data, the first ledger data, and the first contract data as first clearing response information corresponding to the clearing transaction request; and
returning the first clearing response information to the first-type clearing node, to cause the first-type clearing node to recover a sub-ledger corresponding to the first ledger data based on the first clearing response information.

2. The data processing method according to claim 1, wherein the multi-blockchain further comprises a target main chain independent of the first main chain,
wherein a first chain entrance corresponding to the first network has a chain access count threshold indicating a maximum concurrent request access count obtained through the first chain entrance that corresponds to the first main chain and authorized access data information stored in the first chain entrance, the authorized access data information being information of an authorized object allowed to access the first main chain and that is obtained by the first consensus node from the target main chain,
wherein the authorized access data information is generated by a target consensus node associated with the target main chain based on object data information submitted by the authorized object, and
wherein the data processing method further comprises:
obtaining, through the first chain entrance, a data clearing transaction request submitted by the service object through the service clearing node;
incrementing a request access count of the first chain entrance based on the data clearing transaction request to obtain an incremented request access count;
obtaining, based on the incremented request access count not reaching the chain access count threshold, access request data information associated with the service object from the data clearing transaction request;
performing, based on the authorized access data information, access authentication on the service object submitting the access request data information, to obtain an access authentication result of the service object;
determining the service object as the authorized object based on the access authentication result indicating the access request data information is consistent with access registration data information in the authorized access data information; and
using the data clearing transaction request submitted by the service object as the clearing transaction request.

3. The data processing method according to claim 2, wherein the authorized access data information comprises public key information of the service object,
wherein the data clearing transaction request comprises object signature information of the service object obtained based on the service clearing node performing signature addition on a first clearing transaction requested by the service object based on private key information of the service object,
wherein the private key information of the service object and the public key information of the service object form a key pair and are configured by the target consensus node based on the object data information submitted by the service object, and
wherein the obtaining the access request data information comprises:
obtaining the object signature information from the data clearing transaction request;
performing signature verification on the object signature information based on the public key information to obtain a signature verification result;
obtaining, based on the signature verification result indicating the signature verification succeeded, the first clearing transaction; and
using access data information corresponding to the first clearing transaction as the access request data information.

4. The data processing method according to claim 3, further comprising determining, based on the signature verification result indicating the signature verification failed, the service object to be an invalid object, and rejecting the data clearing transaction request.

5. The data processing method according to claim 1, wherein the performing the verification on the identity authority comprises:
writing the target node identifier into the first authority contract on the first main chain;
invoking a first identity verification method of the first authority contract to perform identity verification on the service clearing node having the target node identifier, to obtain an identity verification result;
using, based on the identity verification result indicating a node identity of the service clearing node is of a first identity type, the service clearing node as the first-type clearing node, and invoking a first authority verification method of the first authority contract on the service clearing node, to obtain an authority verification result; and
using, based on the authority verification result indicating the node authority is the first-type clearing authority, the first-type clearing node as the identity authority verification result.

6. The data processing method according to claim 2, wherein a block to which the first service data belongs is a first target block on the first main chain,
wherein a first chaining transaction to which the first service data belongs comprises the target node identifier, the target node identifier is a first node identifier of the first-type clearing node, and the target node identifier indicates the first chaining transaction in the first target block is visible to the first service object, and
wherein the invoking the first authority clearing contract comprises:
invoking a data clearing method of the first authority contract;
accessing the first authority clearing contract, and writing the target node identifier into the first authority clearing contract;
invoking the first authority clearing contract to obtain the first target block associated with the first-type clearing node from the first main chain;
obtaining the first chaining transaction from the first target block;
obtaining the first service data from the first chaining transaction;
obtaining, from a ledger database corresponding to the first main chain, ledger data associated with the first service data as the first ledger data; and
obtaining, from the contract database, contract data associated with the first service data as the first contract data.

7. The data processing method according to claim 6, further comprising:
obtaining a first transaction chaining request through the first chain entrance;
obtaining, from the first transaction chaining request, a first service requested by the first service object and a first to-be-chained transaction corresponding to the first service, wherein the first transaction chaining request is transmitted by the first service object through the first-type clearing node;
writing the first to-be-chained transaction into the first authority contract;
invoking a second authority verification method of the first authority contract;
accessing a first cross-chain reading contract on the first main chain;
reading service processing authority verification information associated with the first service across chains from the target main chain based on the first cross-chain reading contract;
writing the first service into a first service contract on the first main chain when determining, based on the service processing authority verification information, that the service object has service processing authority to process the first service;
obtaining a first service execution result corresponding to the first service by invoking a first service execution method of the first service contract, and using the first service execution result as the first service data;
generating the first chaining transaction based on the first service data and the target node identifier; and
writing the first target block into the first main chain.

8. The data processing method according to claim 7, wherein the first service comprises an electronic bill issuance service, and the first service contract comprises an electronic bill issuance contract, and
wherein the obtaining the first service execution result comprises:
invoking a subcontract accessing method in the first service contract to access the electronic bill issuance contract; and
executing the electronic bill issuance service based on the first service execution method, to obtain a target electronic bill issued for the service object as the first service execution result.

9. The data processing method according to claim 7, wherein the first target block comprises a second chaining transaction other than the first chaining transaction that is invisible to the first service object, and
wherein the data processing method further comprises:
using as the first ledger data, when writing the first target block to the first main chain, a block header of the first target block, data content of the first service data, an associated state root associated with the second chaining transaction, and a Merkle verification path configured to facilitate verification on the first service data, and adding the first ledger data to the ledger database; and
using a contract name, a contract method, and a contract address of the first service contract invoked for executing the first service as the first contract data, and adding the first contract data to the contract database corresponding to the first main chain.

10. The data processing method according to claim 9, wherein the obtaining the ledger data comprises:
searching the ledger database for the block header, the data content, the associated state root, and the Merkle verification path; and
using the block header, the data content, the associated state root, and the Merkle verification path as the first ledger data.

11. A data processing apparatus operating a first consensus node of a first network of a multi-blockchain, comprising:
at least one memory configured to store computer program code; and
at least one processor configured to read the program code and operate as instructed by the program code, the program code comprising:
clearing request obtaining code configured to cause at least one of the at least one processor to:
obtain, through a service clearing node, a clearing transaction request submitted by a service object comprising a first service object associated with a first service network, wherein the first service network is associated with the first network, and the first network is a consensus network corresponding to a first main chain of the multi-blockchain; and
use a node identifier of the service clearing node carried in the clearing transaction request as a target node identifier;
identity authority verification code configured to cause at least one of the at least one processor to perform verification on an identity authority of the service clearing node based on the target node identifier and a first authority contract on the first main chain, to obtain an identity authority verification result corresponding to the service clearing node;
first clearing invoking code configured to cause at least one of the at least one processor to:
invoke a first authority clearing contract associated with the first authority contract to obtain first service data associated with a first-type clearing node corresponding to the first service object that is a service node in the first service network and first ledger data corresponding to the first service data from the first main chain, based on:
the identity authority verification result indicating the service clearing node is the first-type clearing node, and
a node authority of the first-type clearing node being a first-type clearing authority indicating the first-type clearing node has data obtaining authority to obtain the first service data which is visible to the first service object from the first main chain; and
obtain first contract data corresponding to the first ledger data from a contract database corresponding to the first main chain; and
first clearing response returning code configured to cause at least one of the at least one processor to:
use the first service data, the first ledger data, and the first contract data as first clearing response information corresponding to the clearing transaction request; and
return the first clearing response information to the first-type clearing node, to cause the first-type clearing node to recover a sub-ledger corresponding to the first ledger data based on the first clearing response information.

12. The data processing apparatus according to claim 11, wherein the multi-blockchain further comprises a target main chain independent of the first main chain,
wherein a first chain entrance corresponding to the first network has a chain access count threshold indicating a maximum concurrent request access count obtained through the first chain entrance that corresponds to the first main chain and authorized access data information stored in the first chain entrance, the authorized access data information being information of an authorized object allowed to access the first main chain and that is obtained by the first consensus node from the target main chain,
wherein the authorized access data information is generated by a target consensus node associated with the target main chain based on object data information submitted by the authorized object, and
wherein the program code further comprises:
first obtaining code configured to cause at least one of the at least one processor to obtain, through the first chain entrance, a data clearing transaction request submitted by the service object through the service clearing node;
incrementing code configured to cause at least one of the at least one processor to increment a request access count of the first chain entrance based on the data clearing transaction request to obtain an incremented request access count;
second obtaining code configured to cause at least one of the at least one processor to obtain, based on the incremented request access count not reaching the chain access count threshold, access request data information associated with the service object from the data clearing transaction request;
first performing code configured to cause at least one of the at least one processor to perform, based on the authorized access data information, access authentication on the service object submitting the access request data information, to obtain an access authentication result of the service object;
first determining code configured to cause at least one of the at least one processor to determine the service object as the authorized object based on the access authentication result indicating the access request data information is consistent with access registration data information in the authorized access data information; and
clearing transaction code configured to cause at least one of the at least one processor to use the data clearing transaction request submitted by the service object as the clearing transaction request.

13. The data processing apparatus according to claim 12, wherein the authorized access data information comprises public key information of the service object,
wherein the data clearing transaction request comprises object signature information of the service object obtained based on the service clearing node performing signature addition on a first clearing transaction requested by the service object based on private key information of the service object,
wherein the private key information of the service object and the public key information of the service object form a key pair and are configured by the target consensus node based on the object data information submitted by the service object, and
wherein the second obtaining code is configured to cause at least one of the at least one processor to:
obtain the object signature information from the data clearing transaction request;
perform signature verification on the object signature information based on the public key information to obtain a signature verification result;
obtain, based on the signature verification result indicating the signature verification succeeded, the first clearing transaction; and
use access data information corresponding to the first clearing transaction as the access request data information.

14. The data processing apparatus according to claim 13, wherein the program code further comprises second determining code configured to cause at least one of the at least one processor to determine, based on the signature verification result indicating the signature verification failed, the service object to be an invalid object, and rejecting the data clearing transaction request.

15. The data processing apparatus according to claim 11, wherein the identity authority verification code is configured to cause at least one of the at least one processor to:
write the target node identifier into the first authority contract on the first main chain;
invoke a first identity verification method of the first authority contract to perform identity verification on the service clearing node having the target node identifier, to obtain an identity verification result;
use, based on the identity verification result indicating a node identity of the service clearing node is of a first identity type, the service clearing node as the first-type clearing node, and invoking a first authority verification method of the first authority contract on the service clearing node, to obtain an authority verification result; and
use, based on the authority verification result indicating the node authority is the first-type clearing authority, the first-type clearing node as the identity authority verification result.

16. The data processing apparatus according to claim 12, wherein a block to which the first service data belongs is a first target block on the first main chain,
wherein a first chaining transaction to which the first service data belongs comprises the target node identifier, the target node identifier is a first node identifier of the first-type clearing node, and the target node identifier indicates the first chaining transaction in the first target block is visible to the first service object, and
wherein the identity authority verification code configured to cause at least one of the at least one processor to:
invoke a data clearing method of the first authority contract;
access the first authority clearing contract, and writing the target node identifier into the first authority clearing contract;
invoke the first authority clearing contract to obtain the first target block associated with the first-type clearing node from the first main chain;
obtain the first chaining transaction from the first target block;
obtain the first service data from the first chaining transaction;
obtain, from a ledger database corresponding to the first main chain, ledger data associated with the first service data as the first ledger data; and
obtain, from the contract database, contract data associated with the first service data as the first contract data.

17. The data processing apparatus according to claim 16, wherein the program code further comprises:
third obtaining code configured to cause at least one of the at least one processor to obtain a first transaction chaining request through the first chain entrance;
fourth obtaining code configured to cause at least one of the at least one processor to obtain, from the first transaction chaining request, a first service requested by the first service object and a first to-be-chained transaction corresponding to the first service, wherein the first transaction chaining request is transmitted by the first service object through the first-type clearing node;
first writing code configured to configured to cause at least one of the at least one processor to write the first to-be-chained transaction into the first authority contract;
invoking code configured to configured to cause at least one of the at least one processor to invoke a second authority verification method of the first authority contract;
accessing code configured to cause at least one of the at least one processor to access a first cross-chain reading contract on the first main chain;
reading code configured to cause at least one of the at least one processor to read service processing authority verification information associated with the first service across chains from the target main chain based on the first cross-chain reading contract;
second writing configured to cause at least one of the at least one processor to write the first service into a first service contract on the first main chain when determining, based on the service processing authority verification information, that the service object has service processing authority to process the first service;
fifth obtaining configured to cause at least one of the at least one processor to obtain a first service execution result corresponding to the first service by invoking a first service execution method of the first service contract, and using the first service execution result as the first service data;
generating code configured to cause at least one of the at least one processor to generate the first chaining transaction based on the first service data and the target node identifier; and
third writing code configured to cause at least one of the at least one processor to write the first target block into the first main chain.

18. The data processing apparatus according to claim 17, wherein the first service comprises an electronic bill issuance service, and the first service contract comprises an electronic bill issuance contract, and
wherein the fifth obtaining is configured to cause at least one of the at least one processor to:
invoke a subcontract accessing method in the first service contract to access the electronic bill issuance contract; and
execute the electronic bill issuance service based on the first service execution method, to obtain a target electronic bill issued for the service object as the first service execution result.

19. The data processing apparatus according to claim 17, wherein the first target block comprises a second chaining transaction other than the first chaining transaction that is invisible to the first service object, and
wherein the program code further comprises:
ledger database code configured to cause at least one of the at least one processor to:
use as the first service data, when writing the first target block to the first main chain, a block header of the first target block, data content of the first service data, an associated state root associated with the second chaining transaction, and a Merkle verification path configured to facilitate verification on the first service data; and
add the first ledger data to the ledger database; and
contract database code configured to cause at least one of the at least one processor to:
use a contract name, a contract method, and a contract address of the first service contract invoked for executing the first service as the first contract data; and
add the first contract data to the contract database corresponding to the first main chain.

20. A non-transitory computer-readable storage medium, storing computer code for operating a first consensus node of a first network of a multi-blockchain, which, when executed by at least one processor, causes the at least one processor to at least:
obtain, through a service clearing node, a clearing transaction request submitted by a service object comprising a first service object associated with a first service network, wherein the first service network is associated with the first network, and the first network is a consensus network corresponding to a first main chain of the multi-blockchain;
use a node identifier of the service clearing node carried in the clearing transaction request as a target node identifier;
perform verification on an identity authority of the service clearing node based on the target node identifier and a first authority contract on the first main chain, to obtain an identity authority verification result corresponding to the service clearing node;
invoke a first authority clearing contract associated with the first authority contract to obtain first service data associated with a first-type clearing node corresponding to the first service object that is a service node in the first service network and first ledger data corresponding to the first service data from the first main chain, based on:
the identity authority verification result indicating the service clearing node is the first-type clearing node, and
a node authority of the first-type clearing node being a first-type clearing authority indicating the first-type clearing node has data obtaining authority to obtain the first service data which is visible to the first service object from the first main chain;
obtain first contract data corresponding to the first ledger data from a contract database corresponding to the first main chain;
use the first service data, the first ledger data, and the first contract data as first clearing response information corresponding to the clearing transaction request; and
return the first clearing response information to the first-type clearing node, to cause the first-type clearing node to recover a sub-ledger corresponding to the first ledger data based on the first clearing response information.
